(19) United States
(12) Patent Application Publication
(10) Pub. No.: US 2025/0184946 A1
(43) Pub. Date: Jun. 5, 2025

(54) CONFIGURING SIDELINK POSITIONING REFERENCE SIGNALS TRANSMISSION

(71) Applicant: Lenovo (Singapore) Pte. Limited, Singapore (SG)

(72) Inventors: Abir Ben Hadj Fredj, Wiesbaden (DE); Robin Rajan Thomas, Frankfurt (DE); Karthikeyan Ganesan, Kronberg Im Taunus (DE)

(73) Assignee: Lenovo (Singapore) Pte. Limited, Singapore (SG)

(21) Appl. No.: 18/841,952

(22) PCT Filed: Feb. 22, 2023
(86) PCT No.: PCT/IB2023/051644

§ 371 Date: Aug. 27, 2024

Related U.S. Application Data
(60) Provisional application No. 63/315,916, filed on Mar. 2, 2022.

(51) Int. Cl. H04W 64/00; H04L 5/00; H04W 92/18

(52) U.S. Cl. CPC H04W 64/00; H04L 5/0048; H04L 5/0094; H04W 92/18

(57) ABSTRACT

Various aspects of the present disclosure relate to a user equipment (UE) that receives sidelink (SL) positioning reference signals (PRS) configuration transmissions, such as configuration of periodic and semi-persistent SL PRS transmissions between an initiator UE and a responder UE. A network entity, such as a base station, generates the SL PRS configuration and signals the SL PRS configuration to the initiator UE. In one or more implementations, this configuration includes indicating to the initiator UE to transmit SL PRS to a responder UE in one or more of a periodic manner, an aperiodic manner, or a semi-persistent manner. Additionally or alternatively, this configuration includes indicating to the initiator UE to activate or deactivate a CG. Additionally or alternatively, this configuration includes indicating reporting procedures for measurements performed based on periodic or semi-persistent SL PRS transmissions.

### RELATED APPLICATION

This application claims priority to U.S. Patent Application Ser. No. 63/315,916 filed Mar. 2, 2022 entitled “Configuring Sidelink Positioning Reference Signals Transmission,” the disclosure of which is incorporated by reference herein in its entirety.

### TECHNICAL FIELD

The present disclosure relates to wireless communications, and more specifically to configuring sidelink (SL) positioning reference signals (PRS) transmissions.

### BACKGROUND

A wireless communications system may include one or multiple network communication devices, such as base stations, which may be otherwise known as an eNodeB (eNB), a next-generation NodeB (gNB), or other suitable terminology. Each network communication device, such as a base station, may support wireless communications for one or multiple user communication devices, which may be otherwise known as user equipment (UE), or other suitable terminology. The wireless communications system may support wireless communications with one or multiple user communication devices by utilizing resources of the wireless communication system, such as time resources (e.g., symbols, slots, subslots, mini-slots, aggregated slots, subframes, frames, or the like) or frequency resources (e.g., subcarriers, carriers). Additionally, the wireless communications system may support wireless communications across various radio access technologies (RATs) including third generation (3G) RAT, fourth generation (4G) RAT, fifth generation (5G) RAT, and other suitable RATs beyond 5G. In some cases, a wireless communications system may be a non-terrestrial network (NTN), which may support various communication devices for wireless communications in the NTN. For example, an NTN may include network entities onboard non-terrestrial vehicles such as satellites, unmanned aerial vehicles (UAV), and high-altitude platforms systems (HIAPS), as well as network entities on the ground, such as gateway entities capable of transmitting and receiving over long distances.

Various applications that may run on a UE or on a network entity may desire to know the location of the UE. However, as the UEs may be mobile, the locations of the UEs may vary over time. Accordingly, PRS may be used to determine the location or position of a UE.

### SUMMARY

The present disclosure relates to methods, apparatuses, and systems that support configuring sidelink positioning reference signals transmission, including configuration of periodic and semi-persistent SL PRS transmissions between an initiator UE and a responder UE. A network entity, such as a base station, generates the SL PRS configuration and signals the SL PRS configuration to the initiator UE. In one or more implementations, this configuration includes indicating to the initiator UE to transmit SL PRS to a responder UE in one or more of a periodic manner, an aperiodic manner, or a semi-persistent manner. Additionally or alternatively, this configuration includes indicating to the initiator UE to activate or deactivate a configured grant (CG). Additionally or alternatively, this configuration includes indicating reporting procedures for measurements performed based on periodic or semi-persistent SL PRS transmissions. By utilizing the described techniques, a network entity such as a base station is able to dynamically configure a UE to transmit SL PRS in, for example, a periodic manner or a semi-persistent manner.

Some implementations of the method and apparatuses described herein may include wireless communication at a device (e.g., a UE), and the device receives, from a network node, a first control signaling indicating transmission of SL PRS by the device in at least one of a periodic manner, a semi-persistent manner, or an aperiodic manner; and transmits, to a responder UE, a second control signaling including SL PRS based at least in part on the received first control signaling

In some implementations of the method and apparatuses described herein, the network node comprises a base station. Additionally or alternatively, the first control signaling indicates transmission of SL PRS by the device in the semi-persistent manner, and the device further: receives, from the network node, a third control signaling indicating to activate transmission of SL PRS by the device in the semi-persistent manner; and initiates, in response to the third control signaling, transmission of SL PRS by the device to the responder UE in the semi-persistent manner. Additionally or alternatively, the device further: receives, from the network node, a fourth control signaling indicating to deactivate transmission of SL PRS by the device in the semi-persistent manner; and ceases, in response to the fourth control signaling, transmission of SL PRS by the device in the semi-persistent manner. Additionally or alternatively, the device further transmits, to the responder UE, a third control signaling indicating SL PRS transmission in at least one of the periodic, the semi-persistent, or the aperiodic manner based on the first control signaling; and receive, from the responder UE and based at least in part on the third control signaling, a fourth control signaling indicating a PRS measurement. Additionally or alternatively, the device further receives, from the network node, a third control signaling indicating a configured grant (CG) configuration within a positioning frequency layer corresponding to a positioning resource set; and transmits the second control signaling within a CG resource indicated by the CG configuration. Additionally or alternatively, the device further: receives, from the network node, a third control signaling indicating activation or deactivation of a CG resource for the SL PRS, the third control signaling further indicating a positioning resource identifier within a positioning resource set; and activates or deactivates, in accordance with the third control signaling, the CG resource for the SL PRS. Additionally or alternatively, the third control signaling comprises a downlink control information (DCI) signaling. Additionally or alternatively, the device further: receives, from the network node, a third control signaling indicating one or more of a periodic positioning resource for transmitting the second control signaling, a semi-persistent positioning resource for transmitting the second control signaling, or an aperiodic positioning resource for transmitting the second control signaling; and transmits the second control signaling using the indicated one or more of the periodic positioning resource, the semi-persistent positioning resource, and the aperiodic positioning resource. Additionally or alternatively, the device further: receives, from the network node, a fourth control signaling indicating activation or deactivation of a positioning resource within a positioning resource set for the SL PRS; and activates or deactivates, in accordance with the fourth control signaling, the positioning resource for the SL PRS.

Some implementations of the method and apparatuses described herein may include wireless communication at a device (e.g., a base station), and the device transmits, to a UE, a first control signaling indicating transmission of SL PRS by the UE in at least one of a periodic manner, a semi-persistent manner, or an aperiodic manner; and transmits, to the UE, a second control signaling indicating one or more of a periodic positioning resource for transmitting the second control signaling, a semi-persistent positioning resource for transmitting the second control signaling, or an aperiodic positioning resource for transmitting the second control signaling.

In some implementations of the method and apparatuses described herein, the device comprises a base station. Additionally or alternatively, the first control signaling indicates transmission of SL PRS by the UE in the semi-persistent manner, and the device further: transmits, to the UE, a third control signaling indicating to activate transmission of SL PRS by the UE in the semi-persistent manner. Additionally or alternatively, the device further: transmits, to the UE, a fourth control signaling indicating to deactivate transmission of SL PRS by the UE in the semi-persistent manner. Additionally or alternatively, the device further: transmits, to the UE, a third control signaling indicating, for the SL PRS, a CG configuration within a positioning frequency layer corresponding to a positioning resource set. Additionally or alternatively, the device further: transmits, to the UE, a third control signaling indicating activation or deactivation of a configured grant (CG) resource for the SL PRS, the third control signaling further indicating a positioning resource identifier within a positioning resource set. Additionally or alternatively, the third control signaling comprises a DCI signaling. Additionally or alternatively, the device further: transmits, to the UE, a fourth control signaling indicating activation or deactivation of a positioning resource within a positioning resource set for the SL PRS.

Some implementations of the method and apparatuses described herein may include wireless communication at a device (e.g., a UE), and the device receives, from an initiator UE, a first control signaling including SL PRS in at least one of a periodic manner, a semi-persistent manner, or an aperiodic manner; receives, from the initiator UE, a second control signaling indicating SL PRS transmission in at least one of the periodic, the semi-persistent, or the aperiodic manner based on the first control signaling; and transmits, to the initiator UE and based at least in part on the second control signaling, a third control signaling indicating a PRS measurement.

In some implementations of the method and apparatuses described herein, the device further receives the first control signaling within a CG configuration within a positioning frequency layer corresponding to a positioning resource set.

### BRIEF DESCRIPTION OF THE DRAWINGS

Various aspects of the present disclosure for configuring sidelink positioning reference signals transmission are described with reference to the following Figures. The same numbers may be used throughout to reference like features and components shown in the Figures.

FIG. 1 illustrates an example of a wireless communications system that supports configuring sidelink positioning reference signals transmission in accordance with aspects of the present disclosure.

FIG. 2 illustrates an example of positioning performance requirements.

FIG. 3 illustrates an example of absolute and relative positioning scenarios as related to measurement and reporting for configuring sidelink positioning reference signals transmission in accordance with aspects of the present disclosure.

FIG. 4 illustrates an example of a multi-cell round trip time (RTT) procedure as related to measurement and reporting for configuring sidelink positioning reference signals transmission in accordance with aspects of the present disclosure.

FIG. 5 illustrates an example of a system for existing relative range estimation as related to measurement and reporting for configuring sidelink positioning reference signals transmission in accordance with aspects of the present disclosure.

FIG. 6 illustrates an example of a system of new radio (NR) beam-based positioning as related to measurement and reporting for configuring sidelink positioning reference signals transmission in accordance with aspects of the present disclosure.

FIG. 7 illustrates an example of a downlink-time difference of arrival (DL-TDOA) assistance data configuration as related to configuring sidelink positioning reference signals transmission, as described herein.

FIG. 8 illustrates an example of measurement reporting information as related to configuring sidelink positioning reference signals transmission, as described herein.

FIG. 9 shows an example of a SL CG.

FIG. 10 illustrates an example of configuration parameters that may be signaled to the responder UE as related to configuring sidelink positioning reference signals transmission, as described herein.

FIG. 11 illustrates an example block diagram of a device that supports configuring sidelink positioning reference signals transmission in accordance with aspects of the present disclosure.

FIG. 12 illustrates an example block diagram of a device that supports configuring sidelink positioning reference signals transmission in accordance with aspects of the present disclosure.

FIGS. 13, 14, 15, 16, and 17 illustrate flowcharts of methods that support configuring sidelink positioning reference signals transmission in accordance with aspects of the present disclosure.

### DETAILED DESCRIPTION

Implementations of configuring sidelink positioning reference signals transmission are described, such as related to methods, apparatuses, and systems that support configuration of periodic and semi-persistent SL PRS transmissions between an initiator UE and a responder UE. A network entity, such as a base station, generates the SL PRS configuration and signals the SL PRS configuration to the initiator UE. In one or more implementations, this SL PRS configuration includes indicating to the initiator UE to transmit SL PRS to a responder UE in one or more of a periodic manner, an aperiodic manner, or a semi-persistent manner.

Additionally or alternatively, this SL PRS configuration includes indicating to the initiator UE to activate or deactivate a CG. When activated, the CG provides a SL resource that can be used by the initiator UE without a scheduling request (SR) to transmit or receive SL PRS.

Additionally or alternatively, this configuration includes indicating reporting procedures for measurements performed based on periodic or semi-persistent SL PRS transmissions. This allows the initiator UE to provide various information regarding the positioning measurements obtained by the initiator UE (e.g., based on SL RAT-dependent measurements) to a responder UE.

By utilizing the described techniques, a network entity such as a base station is able to dynamically configure a UE to transmit SL PRS in, for example, a periodic manner or a semi-persistent manner. Furthermore, the described techniques are tailored for PRS. In contrast to solutions that allow for SL data transmission, the described techniques avoid the need to perform various operations associated with SL data transmission, such as providing feedback (e.g., hybrid automatic repeat request (HARQ) feedback), decoding data, and so forth. Additionally, the described techniques provide a standalone medium (e.g., a channel) dedicated to PRS, which avoids interference that may be encountered if the PRS were multiplexed with the data on the same channel.

Aspects of the present disclosure are described in the context of a wireless communications system. Aspects of the present disclosure are further illustrated and described with reference to device diagrams and flowcharts that relate to configuring sidelink positioning reference signals transmission.

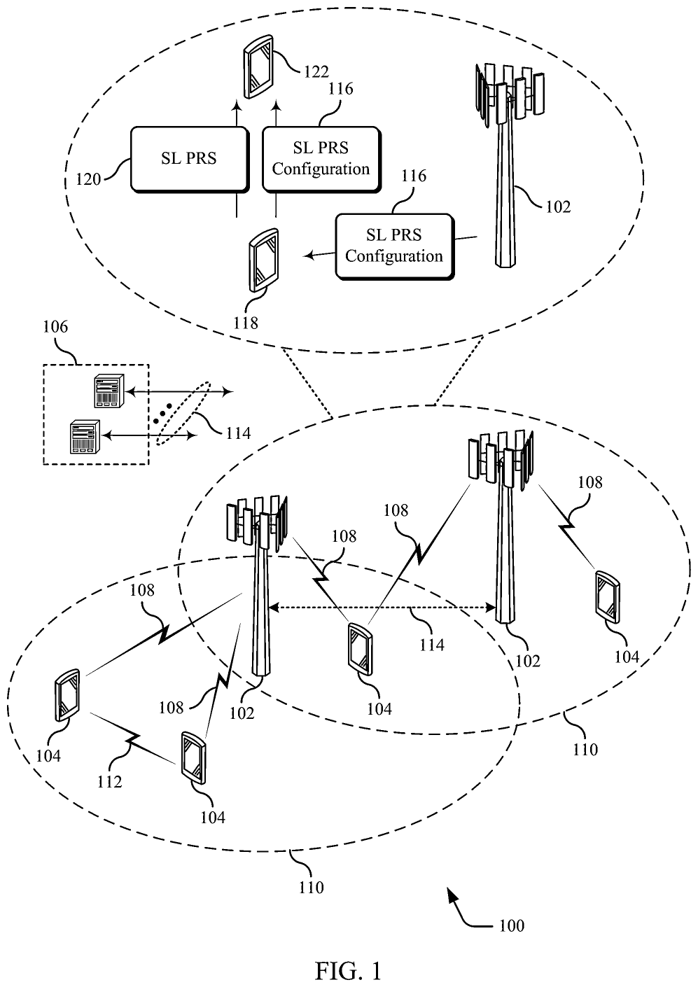

FIG. 1 illustrates an example of a wireless communications system 100 that supports configuring sidelink positioning reference signals transmission in accordance with aspects of the present disclosure. The wireless communications system 100 may include one or more base stations 102, one or more UEs 104, and a core network 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as a NR network. In other implementations, the wireless communications system 100 may be a combination of a 4G network and a 5G network. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more base stations 102 may be dispersed throughout a geographic region to form the wireless communications system 100. One or more of the base stations 102 described herein may be, or include, or may be referred to as a base transceiver station, an access point, a NodeB, an eNodeB (eNB), a next-generation NodeB (gNB), a Radio Head (RH), a relay node, an integrated access and backhaul (IAB) node, or other suitable terminology. A base station 102 and a UE 104 may communicate via a communication link 108, which may be a wireless or wired connection. For example, a base station 102 and a UE 104 may perform wireless communication over a NR-Uu interface.

A base station 102 may provide a geographic coverage area 110 for which the base station 102 may support services (e.g., voice, video, packet data, messaging, broadcast, etc.) for one or more UEs 104 within the geographic coverage area. For example, a base station 102 and a UE 104 may support wireless communication of signals related to services (e.g., voice, video, packet data, messaging, broadcast, etc.) according to one or multiple radio access technologies. In some implementations, a base station 102 may be moveable, such as when implemented as a gNB onboard a satellite or other non-terrestrial station (NTS) associated with a non-terrestrial network (NTN). In some implementations, different geographic coverage areas 110 associated with the same or different radio access technologies may overlap, and different geographic coverage areas 110 may be associated with different base stations 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region or coverage area 110 of the wireless communications system 100. A UE 104 may include or may be referred to as a mobile device, a wireless device, a remote device, a handheld device, a customer premise equipment (CPE), a subscriber device, or as some other suitable terminology. In some implementations, the UE 104 may be referred to as a unit, a station, a terminal, or a client, among other examples. Additionally, or alternatively, a UE 104 may be referred to as an Internet-of-Things (IoT) device, an Internet-of-Everything (IoE) device, or as a machine-type communication (MTC) device, among other examples. In some implementations, a UE 104 may be stationary in the wireless communications system 100. In other implementations, a UE 104 may be mobile in the wireless communications system 100, such as an earth station in motion (ESIM).

The one or more UEs 104 may be devices in different forms or having different capabilities. Some examples of UEs 104 are illustrated in FIG. 1. A UE 104 may be capable of communicating with various types of devices, such as the base stations 102, other UEs 104, or network equipment (e.g., the core network 106, a relay device, a gateway device, an integrated access and backhaul (IAB) node, a location server that implements a location management function (LMF), or other network equipment). Additionally, or alternatively, a UE 104 may support communication with other base stations 102 or UEs 104, which may act as relays in the wireless communications system 100.

A UE 104 may also support wireless communication directly with other UEs 104 over a communication link 112. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 112 may be referred to as a sidelink. For example, a UE 104 may support wireless communication directly with another UE 104 over a PC5 interface.

A base station 102 may support communications with the core network 106, or with another base station 102, or both. For example, a base station 102 may interface with the core network 106 through one or more backhaul links 114 (e.g., via an S1, N2, or other network interface). The base stations 102 may communicate with each other over the backhaul links 114 (e.g., via an X2, Xn, or another network interface). In some implementations, the base stations 102 may communicate with each other directly (e.g., between the base stations 102). In some other implementations, the base stations 102 may communicate with each other indirectly (e.g., via the core network 106). In some implementations, one or more base stations 102 may include subcomponents, such as an access network entity, which may be an example of an access node controller (ANC). The ANC may communicate with the one or more UEs 104 through one or more other access network transmission entities, which may be referred to as remote radio heads, smart radio heads, gateways, transmission-reception points (TRPs), and other network nodes and/or entities.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)), and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management for the one or more UEs 104 served by the one or more base stations 102 associated with the core network 106.

According to implementations, one or more of the UEs 104 and base stations 102 are operable to implement various aspects of configuring sidelink positioning reference signals transmission, as described herein. For instance, a base station 102 can transmit (e.g., using radio resource control (RRC) signaling) an SL PRS configuration 116 to a UE 104 that is referred to as an initiator UE, illustrated as initiator UE 118. The initiator UE 118 transmits or receives SL PRS based at least in part on the SL PRS configuration 116 as discussed further below. In one or more implementations, the SL PRS configuration 116 includes an indication of whether to transmit SL PRS in one or more of a periodic manner, an aperiodic manner, or a semi-persistent manner. Additionally or alternatively, the SL PRS configuration 116 includes an indication of a CG activation or deactivation. Additionally or alternatively, the SL PRS includes an indication of reporting procedures for measurements performed based on periodic or semi-persistent SL PRS transmissions.

The initiator UE 118 can transmit (e.g., using a PC5 vehicle-to-everything (V2X) interface) the SL PRS configuration 116 to another UE 104 that is referred to as a responder UE, illustrated as responder UE 122. The responder UE transmits or receives SL PRS 120 based at least in part on the SL PRS configuration 116 as discussed further below.

The techniques described herein allow for periodic location estimation, e.g., relative location estimation or absolute location estimation. For example, the initiator UE 118 (which is initiating the absolute location information procedure or relative location information procedure), perform the location estimation procedure on a periodic basis with the responder UEs 122 measuring, according to each periodicity, a set of measurements and reporting the set of measurements accordingly to the initiator UE 118. Additionally or alternatively, the location procedure can be a one-shot location procedure where the initiator UE 118 transmits a one-shot signal to the responder UE 122 and receives a measurement report from the responder UE 122. The configured grant and semi-persistent transmissions discussed herein allow this periodic location determination, or deferred location determination (e.g., location determination at a certain time or a requested time in the future).

The ULE 104 communicates with the base station 102 using any of a variety of types of control signaling, such as at least one of radio resource control (RRC), downlink control information (DCI), uplink control information (UCI), medium access control (MAC) control element (CE), HARQ (e.g., SL HARQ), or the like. Similarly, the UE 104 communicates with other UEs 104 using any of a variety of types of control signaling, such as at least one of RRC, sidelink control information (SCI), MAC CE, HARQ (e.g., SL HARQ), or the like.

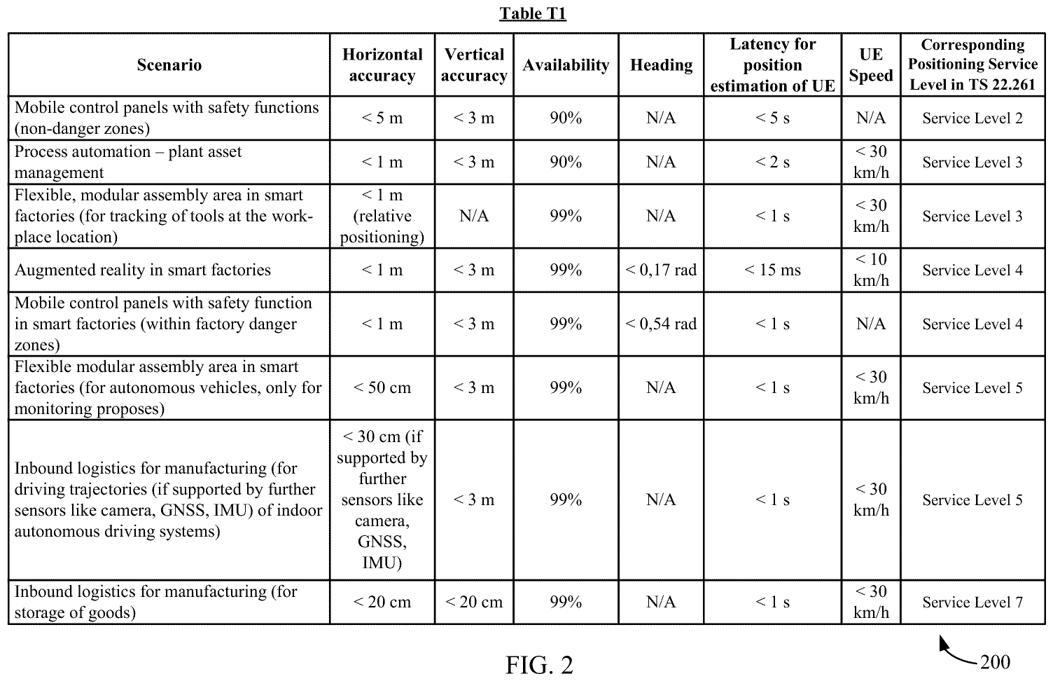

FIG. 2 illustrates an example 200 of positioning performance requirements. The example 200 includes a Table T1 listing industrial Internet of things (IIoT) positioning performance requirements (for release 17), which are especially stringent with respect to accuracy, latency and reliability. Table T1 shows the positioning performance requirements for different scenarios in an IIoT or indoor factory setting.

The supported positioning techniques (release 16) are listed in Table T2, and separate positioning techniques can be currently configured and performed based on the requirements of the location management function (LMF) and UE capabilities. The transmission of PRS enable the UE to perform UE positioning-related measurements to enable the computation of a UE's location estimate and are configured per transmission reception point (TRP), where a TRP may transmit one or more beams. Various RAT-dependent positioning techniques (also referred to as positioning methods, or positioning procedures) are supported for a UE, for UE-assisted, LMF-based, and/or for next generation radio access network (NG-RAN) node assisted. The RAT-dependent positioning techniques that are supported include DL-TDOA, downlink-angle of departure (DL-AoD), multi-round trip time (multi-RTT), new radio enhanced cell-ID (NR E-CID); uplink-time difference of arrival (UL-TDOA); and uplink-angle of arrival (UL-AoA).

TABLE T2
Supported Rel-16 UE positioning methods

| | | UE-assisted, | NG-RAN node | |
|---|---|---|---|---|
| Method | UE-based | LMF-based | assisted | SUPL |
| A-GNSS | Yes | Yes | No | Yes (UE-based and UE-assisted) |
| OTDOA ^{Note1, Note 2} | No | Yes | No | Yes (UE-assisted) |
| E-CID ^{Note 4} | No | Yes | Yes | Yes for E-UTRA (UE-assisted) |
| Sensor | Yes | Yes | No | No |
| WLAN | Yes | Yes | No | Yes |
| Bluetooth | No | Yes | No | No |
| TBS ^{Note 5} | Yes | Yes | No | Yes (MBS) |
| DL-TDOA | Yes | Yes | No | No |
| DL-AoD | Yes | Yes | No | No |
| Multi-RTT | No | Yes | Yes | No |
| NR E-CID | No | Yes | FFS | No |
| UL-TDOA | No | No | Yes | No |
| UL-AoA | No | No | Yes | No |

^{NOTE 1:} This includes terrestrial beacon system (TBS) positioning based on PRS signals.
^{NOTE 2:} In this version of the specification only observed time difference of arrival (OTDOA) based on LTE signals is supported.
NOTE 3:
Void.
^{NOTE 4:} This includes Cell-ID for NR method.
^{NOTE 5:} In this version of the specification only for TBS positioning based on MBS signals.
NOTE 6:
Void

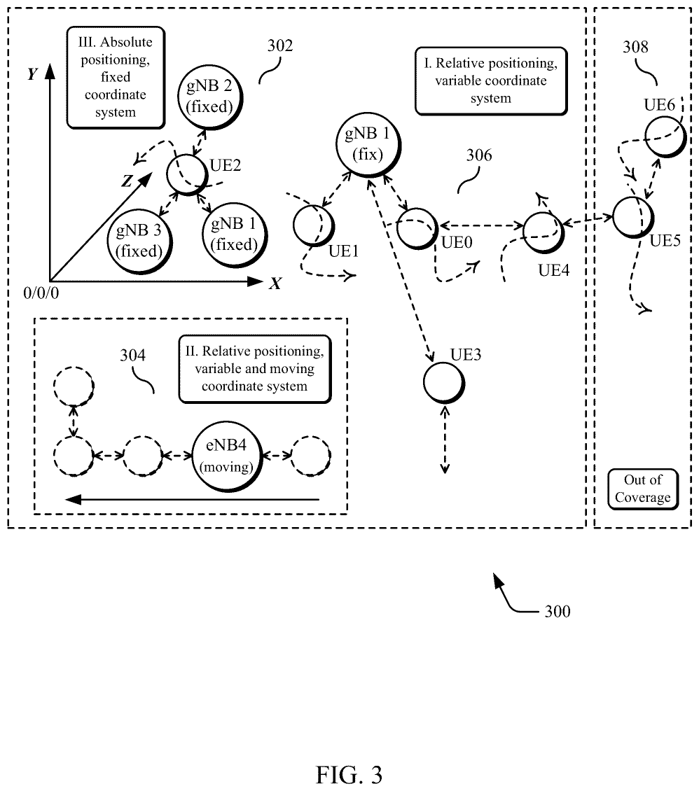

FIG. 3 illustrates an example 300 of absolute and relative positioning scenarios as related to measurement and reporting for configuring sidelink positioning reference signals transmission in accordance with aspects of the present disclosure. The network devices described with reference to example 300 may use and/or be implemented with the wireless communications system 100 and include UEs 104 and base stations 102 (e.g., eNB, gNB). The example 300 is an overview of absolute and relative positioning scenarios as defined in the architectural (stage 1) specifications using three different co-ordinate systems, including (III) a conventional absolute positioning, fixed coordinate system at 302; (II) a relative positioning, variable and moving coordinate system at 304; and (I) a relative positioning, variable coordinate system at 306. Notably, the relative positioning, variable coordinate system at 306 is based on relative device positions in a variable coordinate system, where the reference may be always changing with the multiple nodes that are moving in different directions. The example 300 also includes a scenario 308 for an out of coverage area in which UEs need to determine relative position with respect to each other.

With reference to RAT-dependent positioning techniques, the DL-TDOA positioning technique utilizes at least three network nodes for positioning based on triangulation. The DL-TDOA positioning method makes use of the downlink reference signal time difference (RSTD) (and optionally DL PRS RSRP) of downlink signals received from multiple transmission points (TPs) at the UE. The UE measures the downlink RSTD (and optionally DL PRS RSRP) of the received signals using assistance data received from the positioning server (also referred to herein as the location server), and the resulting measurements are used along with other configuration information to locate the UE in relation to the neighboring TPs.

The DL-AoD positioning technique makes use of the measured downlink PRS reference signal received power (RSRP) (DL PRS RSRP) of downlink signals received from multiple TPs at the UE. The UE measures the DL PRS RSRP of the received signals using assistance data received from the positioning server (also referred to herein as the location server), and the resulting measurements are used along with other configuration information to locate the UE in relation to the neighboring TPs.

FIG. 4 illustrates an example 400 of a multi-cell RTT procedure as related to measurement and reporting for configuring sidelink positioning reference signals transmission in accordance with aspects of the present disclosure. The multi-RTT positioning technique makes use of the UE Rx-Tx measurements and DL PRS RSRP of downlink signals received from multiple TRPs, as measured by the UE and the measured gNB Rx-Tx measurements and uplink sounding reference signal (SRS) RSRP (UL SRS-RSRP) at multiple TRPs of uplink signals transmitted from UE. The UE measures the UE Rx-Tx measurements (and optionally DL PRS RSRP of the received signals) using assistance data received from the positioning server (also referred to herein as the location server), and the TRPs the gNB Rx-Tx measurements (and optionally UL SRS-RSRP of the received signals) using assistance data received from the positioning server. The measurements are used to determine the RTT at the positioning server, which are used to estimate the location of the UE. The multi-RTT is only supported for UE-assisted and NG-RAN assisted positioning techniques as noted in Table T2.

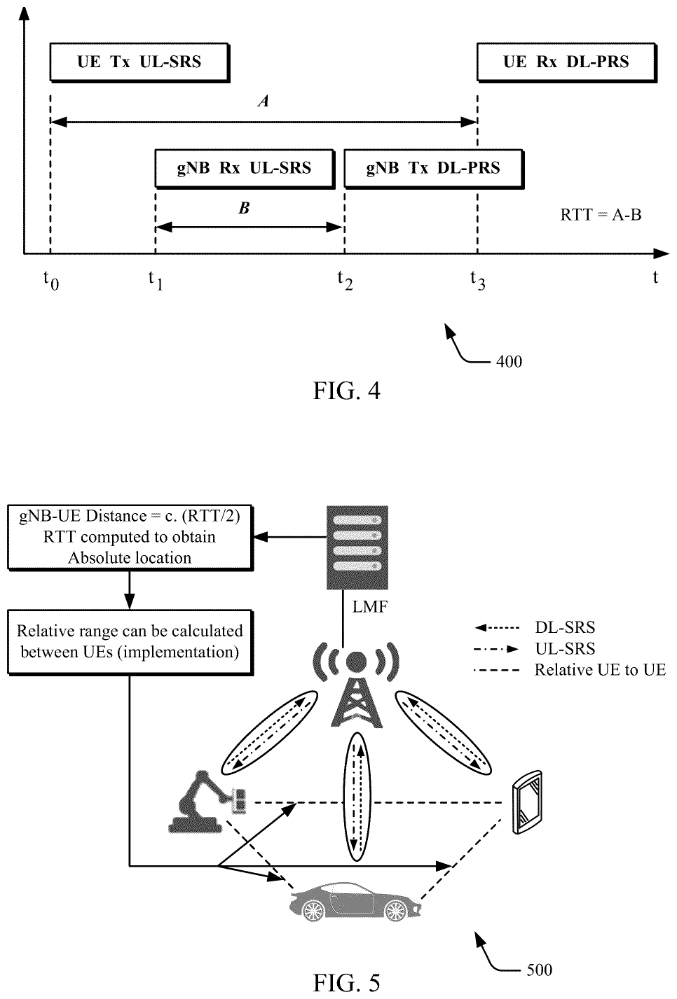

FIG. 5 illustrates an example of a system 500 for existing relative range estimation as related to measurement and reporting for configuring sidelink positioning reference signals transmission in accordance with aspects of the present disclosure. The system 500 illustrates the relative range estimation using the existing single gNB RTT positioning framework. The location server (LMF) can configure measurements to the different UEs, and then the target UEs can report their measurements in a transparent way to the location server. The location server can compute the absolute location, but in order to get the relative distance between two of the UEs, it would need prior information, such as the locations of the target UEs.

For the NR enhanced cell ID (E-CID) positioning technique, the position of a UE is estimated with the knowledge of its serving ng-eNB, gNB, and cell, and is based on LTE signals. The information about the serving ng-eNB, gNB, and cell may be obtained by paging, registration, or other methods. The NR enhanced cell-ID (NR E-CID) positioning refers to techniques which use additional UE measurements and/or NR radio resources and other measurements to improve the UE location estimate using NR signals. Although enhanced cell-ID (E-CID) positioning may utilize some of the same measurements as the measurement control system in the RRC protocol, the UE may not make additional measurements for the sole purpose of positioning (i.e., the positioning procedures do not supply a measurement configuration or measurement control message, and the UE reports the measurements that it has available rather than being required to take additional measurement actions).

The uplink time difference of arrival (UL-TDOA) positioning technique makes use of the UL-TDOA (and optionally UL SRS-RSRP) at multiple reception points (RPs) of uplink signals transmitted from UE. The RPs measure the UL-TDOA (and optionally UL SRS-RSRP) of the received signals using assistance data received from the positioning server, and the resulting measurements are used along with other configuration information to estimate the location of the UE.

The uplink angle of arrival (UL-AoA) positioning technique makes use of the measured azimuth and the zenith of arrival at multiple RPs of uplink signals transmitted from UE. The RPs measure azimuth-AoA and zenith-AoA of the received signals using assistance data received from the positioning server (also referred to herein as the location server), and the resulting measurements are used along with other configuration information to estimate the location of the UE.

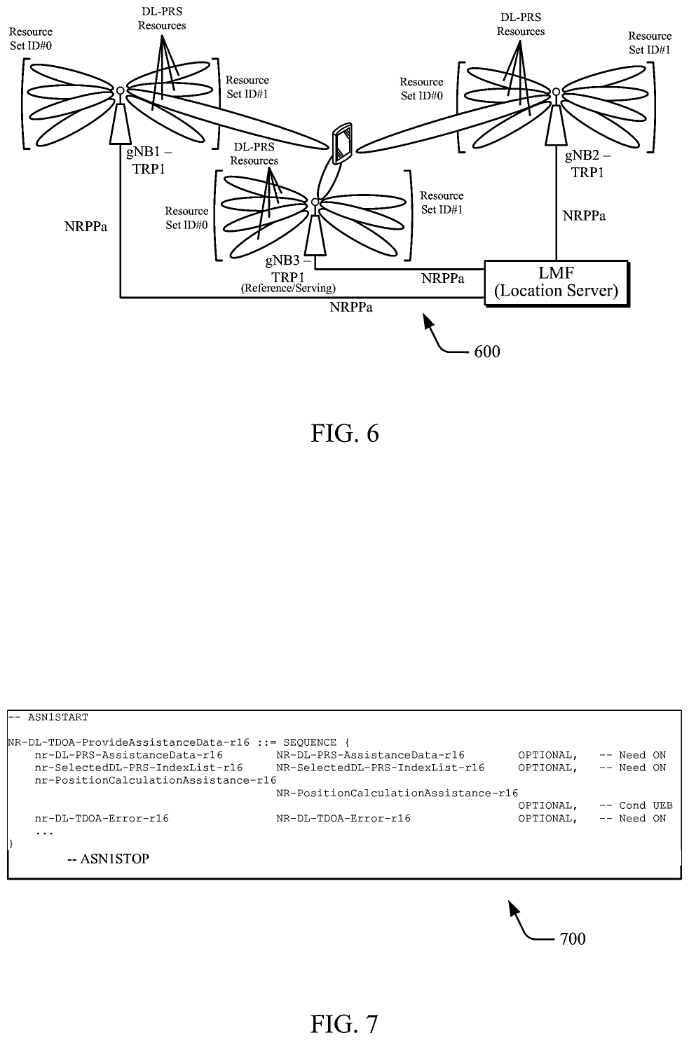

FIG. 6 illustrates an example of a system 600 of NR beam-based positioning as related to measurement and reporting for configuring sidelink positioning reference signals transmission in accordance with aspects of the present disclosure. The system 600 illustrates a UE 104 and base stations 102 (e.g., gNB). The PRS can be transmitted by different base stations (serving and neighboring) using narrow beams over FR1 and FR2 as illustrated in the example system 600, which is relatively different when compared to LTE where the PRS was transmitted across the whole cell. The PRS can be locally associated with a PRS Resource identifier (ID) and Resource Set ID for a base station (TRP). Similarly, UE positioning measurements such as Reference Signal Time Difference (RSTD) and PRS RSRP measurements are made between beams (e.g., between a different pair of DL PRS resources or DL PRS resource sets) as opposed to different cells as was the case in LTE. In addition, there are additional UL positioning methods for the network to exploit in order to compute the target UE's location.

The Tables T3 and T4 show the reference signal to measurements mapping for each of the supported RAT-dependent positioning techniques at the UE and gNB, respectively. The RAT-dependent positioning techniques may utilize the 3GPP RAT and core network entities to perform the position estimation of the UE, which are differentiated from RAT-independent positioning techniques, which rely on global navigation satellite system (GNSS), inertial measurement unit (IMU) sensor, WLAN, and Bluetooth technologies for performing target device (UE) positioning.

TABLE T3
UE measurements to enable RAT-
dependent positioning techniques.

| | | To facilitate |
|---|---|---|
| | | support of the |
| DL/UL Reference | | positioning |
| Signals | UE Measurements | techniques |
| Rel. 16 DL PRS | DL RSTD | DL-TDOA |
| Rel. 16 DL PRS | DL PRS RSRP | DL-TDOA, DL-AoD, |
| | | Multi-RTT |
| Rel. 16 DL PRS/ | UE Rx-Tx | Multi-RTT |
| Rel. 16 SRS for | time difference | |
| positioning | | |
| Rel. 15 SSB/CSI-RS | SS-RSRP(RSRP for RRM), | NR E-CID |
| for RRM | SS-RSRQ(for RRM), | |
| | CSI-RSRP (for RRM), | |
| | CSI-RSRQ (for RRM), | |
| | SS-RSRPB (for RRM) | |

TABLE T4
gNB measurements to enable RAT-dependent
positioning techniques.

| | | To facilitate |
|---|---|---|
| | | support of the |
| DL/UL Reference | | positioning |
| Signals | gNB Measurements | techniques |
| Rel. 16 SRS for | UL RTOA | UL-TDOA |
| positioning | | |
| Rel. 16 SRS for | UL SRS-REFERENCE | UL-TDOA, UL-AoA, |
| positioning | SIGNAL RECEIVED | Multi-RTT |
| | POWER (RSRP) | |
| Rel. 16 SRS for | gNB Rx-Tx | Multi-RTT |
| positioning, Rel. 16 | time difference | |
| DL PRS | | |
| Rel. 16 SRS for | AoA and ZoA | UL-AoA, Multi-RTT |
| positioning | | |

UE measurements have been defined (e.g., release 16), which are applicable to DL-based positioning techniques.

FIG. 7 illustrates an example 700 of a DL-TDOA assistance data configuration as related to configuring sidelink positioning reference signals transmission, as described herein. The information element (IE) NR-DL-TDOA-ProvideAssistanceData is used by the location server to provide assistance data to enable UE-assisted and UE-based NR downlink TDOA. It may also be used to provide NR DL TDOA positioning specific error reason.

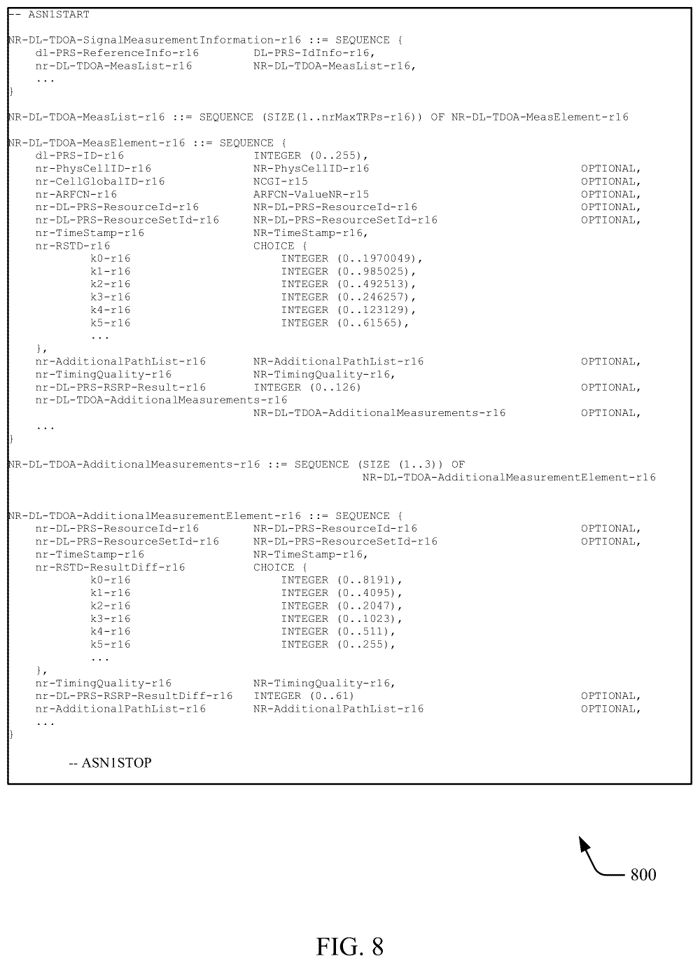

FIG. 8 illustrates an example 800 of measurement reporting information as related to configuring sidelink positioning reference signals transmission, as described herein. The IE NR-DL-TDOA-SignalMeasurementInformation is used by the target device to provide NR-DL TDOA measurements to the location server. The measurements are provided as a list of TRPs, where the first TRP in the list is used as reference TRP in case RSTD measurements are reported. The first TRP in the list may or may not be the reference TRP indicated in the NR-DL-PRS-AssistanceData. Furthermore, the target device selects a reference resource per TRP, and compiles the measurements per TRP based on the selected reference resource.

With reference to RAT-dependent positioning measurements, the different downlink measurements, including DL PRS RSRP, downlink RSTD, and UE Rx-Tx time difference required for the supported RAT-dependent positioning techniques are shown in Table T5. The measurement configurations may include four (4) pair of downlink RSTD measurements performed per pair of cells, and each measurement is performed between a different pair of downlink PRS resources or resource sets with a single reference timing; and eight (8) downlink PRS reference signal received power (RSRP) measurements can be performed on different downlink PRS resources from the same cell.

TABLE T5
Downlink measurements for downlink-based positioning techniques.
DL PRS reference signal received power (DL PRS-RSRP)

| | |
|---|---|
| Definition | DL PRS-RSRP, is the linear average over the power contributions (in [W]) of |
| | the resource elements that carry DL PRS reference signals configured for |
| | RSRP measurements within the considered measurement frequency |
| | bandwidth. |
| | For frequency range 1, the reference point for the DL PRS-RSRP shall be the |
| | antenna connector of the UE. For frequency range 2, DL PRS-RSRP shall be |
| | measured based on the combined signal from antenna elements corresponding |
| | to a given receiver branch. For frequency range 1 and 2, if receiver diversity is |
| | in use by the UE, the reported DL PRS-RSRP value shall not be lower than |
| | the corresponding DL PRS-RSRP of any of the individual receiver branches. |
| Applicable for | RRC_CONNECTED intra-frequency, |
| | RRC_CONNECTED inter-frequency |

DL reference signal time difference (DL RSTD)

| | |
|---|---|
| Definition | DL reference signal time difference (DL RSTD) is the DL relative timing |
| | difference between the positioning node j and the reference positioning node i, |
| | defined as T_{SubframeRxj} − T_{SubframeRxi}, |
| | Where: |
| | T_{SubframeRxj} is the time when the UE receives the start of one subframe from |
| | positioning node j. |
| | T_{SubframeRxi} is the time when the UE receives the corresponding start of one |
| | subframe from positioning node i that is closest in time to the subframe |
| | received from positioning node j. |
| | Multiple DL PRS resources can be used to determine the start of one subframe |
| | from a positioning node. |
| | For frequency range 1, the reference point for the DL RSTD shall be the |
| | antenna connector of the UE. For frequency range 2, the reference point for |
| | the DL RSTD shall be the antenna of the UE. |

UE Rx − Tx time difference

| | |
|---|---|
| Definition | The UE Rx − Tx time difference is defined as T_{UE-RX} − T_{UE-TX} |
| | Where: |
| | T_{UE-RX} is the UE received timing of downlink subframe #i from a positioning |
| | node, defined by the first detected path in time. |
| | T_{UE-TX} is the UE transmit timing of uplink subframe #j that is closest in time to |
| | the subframe #i received from the positioning node. |
| | Multiple DL PRS resources can be used to determine the start of one subframe |
| | of the first arrival path of the positioning node. |
| | For frequency range 1, the reference point for T_{UE-RX} measurement shall be the |
| | Rx antenna connector of the UE and the reference point for T_{UE-TX} |
| | measurement shall be the Tx antenna connector of the UE. For frequency |
| | range 2, the reference point for T_{UE-RX} measurement shall be the Rx antenna of |
| | the UE and the reference point for T_{UE-TX} measurement shall be the Tx antenna |
| | of the UE. |
| Applicable for | RRC_CONNECTED intra-frequency |
| | RRC_CONNECTED inter-frequency |

A positioning frequency layer consists of one or more downlink PRS resource sets, each of which consists of one or more downlink PRS resources as described in 3GPP technical specification (TS) 38.214. For sequence generation, the UE assumes the reference-signal sequence r(m) is defined by

$$r ( m ) = \frac{1}{\sqrt{2}} ( 1 - 2 c ( 2 m ) ) + j \frac{1}{\sqrt{2}} ( 1 - 2 c ( 2 m + 1 ) )$$

where the pseudo-random sequence c(i) is defined in clause 5.2.1. The pseudo-random sequence generator shall be initialised with

$${c}_{i n i t} = ( {2}^{22} ⌊ \frac{{n}_{ID , seq}^{PRS}}{1024} ⌋ + {2}^{10} ( {N}_{symb}^{slot} {n}_{s , f}^{μ} + l + 1 ) ( 2 ( {n}_{ID , seq}^{PRS} mod 1024 ) + 1 ) + ( {n}_{ID , seq}^{PRS} mod 1024 ) ) mod {2}^{31}$$

where n_{s,f}^{μ} is the slot number, the downlink PRS sequence ID n_{ID,seq}^{PRS}∈{0, 1, . . . , 4095} is given by the higher-layer parameter dl-PRS-SequenceID, and l is the orthogonal frequency division multiplexing (OFDM) symbol within the slot to which the sequence is mapped.

In mapping to physical resources in a downlink PRS resource, for each downlink PRS resource configured, the UE assumes the sequence r(m) is scaled with a factor β_{PRS} and mapped to resources elements (k, l)_{p,μ} according to

$${a}_{k , l}^{( p , μ )} = {β}_{PRS} r ( m )$$

$$m = 0 , 1 , …$$

$$k = m {K}_{comb}^{PRS} + ( ( {k}_{offset}^{PRS} + {k}^{′} ) mod {K}_{comb}^{PRS} )$$

$$l = {l}_{start}^{PRS} , {l}_{start}^{PRS} + 1 , … , {l}_{start}^{PRS} + {L}_{PRS} - 1$$

when the following conditions are fulfilled:
the resource element (k, l)_{p,μ} is within the resource blocks occupied by the downlink PRS resource for which the UE is configured;
the symbol l is not used by any synchronization signal/physical broadcast channel (SS/PBCH) block used by a serving cell for downlink PRS transmitted from the same serving cell or any SS/PBCH block from a non-serving cell whose time frequency location is provided to the UE by higher layers for downlink PRS transmitted from the same non-serving cell;
the slot number satisfies the conditions in clause 7.4.1.7.4 of 3GPP TS 38.211.
   and where
the antenna port p=5000
lₛₜₐᵣₜ^{PRS} is the first symbol of the downlink PRS within a slot and given by the higher-layer parameter dl-PRS-ResourceSymbolOffset;
the size of the downlink PRS resource in the time domain L_{PRS}∈{2,4,6,12} is given by the higher-layer parameter dl-PRS-NumSymbols;
the comb size K_{comb}^{PRS}ε{2, 4, 6, 12} is given by the higher-layer parameter dl-PRS-CombSizeN such that the combination {L_{PRS}, K_{comb}^{PRS}} is one of {2, 2}, {4, 2}, {6, 2}, {12, 2}, {4, 4}, {12, 4}, {6, 6}, {12, 6} and {12, 12};
the resource-element offset k_{offfset}^{PRS}∈{0, 1, . . . , K_{comb}^{PRS}−1} is obtained from the higher-layer parameter dl-PRS-CombSizeN-AndReOffset;
the quantity k′ is given by Table T6.

The reference point for k=0 is the location of the point A of the positioning frequency layer, in which the downlink PRS resource is configured where point A is given by the higher-layer parameter dl-PRS-PointA.

Table T6 shows the frequency offset k′ as a function of l−lₛₜₐᵣₜ^{PRS}.

TABLE T6

| | Symbol number within the downlink PRS resource l − lₛₜₐᵣₜ^{PRS} | | | | | | | | | | | |
|---|---|---|---|---|---|---|---|---|---|---|---|---|
| K_{comb}^{PRS} | 0 | 1 | 2 | 3 | 4 | 5 | 6 | 7 | 8 | 9 | 10 | 11 |
| 2 | 0 | 1 | 0 | 1 | 0 | 1 | 0 | 1 | 0 | 1 | 0 | 1 |
| 4 | 0 | 2 | 1 | 3 | 0 | 2 | 1 | 3 | 0 | 2 | 1 | 3 |
| 6 | 0 | 3 | 1 | 4 | 2 | 5 | 0 | 3 | 1 | 4 | 2 | 5 |
| 12 | 0 | 6 | 3 | 9 | 1 | 7 | 4 | 10 | 2 | 8 | 5 | 11 |

In mapping to slots in a downlink PRS resource set, for a downlink PRS resource in a downlink PRS resource set, the UE assumes the downlink PRS resource being transmitted when the slot and frame numbers fulfil

$$( {N}_{slot}^{frame , μ} {n}_{f} + {n}_{s , f}^{μ} - {T}_{offset}^{PRS} - {T}_{offset , res}^{PRS} ) mod {T}_{per}^{PRS} ∈ {\{ {iT}_{gap}^{PRS} \}}_{i = 0}^{{T}_{rep}^{PRS} - 1}$$

and one of the following conditions are fulfilled:
the higher-layer parameters dl-PRS-MutingOption1 and dl-PRS-MutingOption2 are not provided;
the higher-layer parameter dl-PRS-MutingOption1 is provided with bitmap {b¹} but dl-PRS-MutingOption2 with bitmap {b²} is not provided, and bit b is set;
the higher-layer parameter dl-PRS-MutingOption2 is provided with bitmap {b²} but dl-PRS-MutingOption1 with bitmap {b¹} is not provided, and bit bᵢ² is set;
the higher-layer parameters dl-PRS-MutingOption1 with bitmap {b¹} and dl-PRS-MutingOption2 with {b²} are both provided, and both bit bᵢ¹ and bᵢ² are set.
   where
bᵢ¹ is bit i=└(Nₛₗₒₜ^{frame,μ}n_{f}=n_{s,f}^{μ}−T_{offset}^{PRS}−T_{offset,res}^{PRS})/(T_{muting}^{PRS}Tₚₑᵣ^{PRS})┘ mod L in the bitmap given by the higher-layer parameter dl-PRS-MutingOption1 where L∈{2, 4, 6, 8, 16, 32} is the size of the bitmap;
bᵢ² is bit i=└((Nₛₗₒₜ^{frame,μ}n_{f}+n_{s,f}^{μ}−T_{offset}^{PRS}−T_{offset,res}^{PRS})mod Tₚₑᵣ^{PRS})/T_{gap}^{PRS}┘ mod Tᵣₑₚ^{PRS} in the bitmap given by the higher-layer parameter dl-PRS-MutingOption2;
the periodicity Tₚₑᵣ^{PRS}∈2^{μ}{4, 5, 8, 10, 16, 20, 32, 40, 64, 80, 160, 320, 640, 1280, 2560, 5120, 10240} and the slot offset T_{offset}^{PRS}∈{0, 1, . . . , Tₚₑᵣ^{PRS}−1} are given by the higher-layer parameter dl-PRS-Periodicity-and-ResourceSetSlotOffset;
the downlink PRS resource slot offset T_{offset,res}^{PRS} is given by the higher-layer parameter dl-PRS-ResourceSlotOffset;
the repetition factor Tᵣₑₚ^{PRS}∈{1,2,4,6,8,16,32} is given by the higher-layer parameter dl-PRS-ResourceRepetitionFactor;
the muting repetition factor T_{muting}^{PRS} is given by the higher-layer parameter dl-PRS-MutingBitRepetitionFactor;
the time gap T_{gap}^{PRS}∈{1,2,4,8,16,32} is given by the higher-layer parameter dl-PRS-ResourceTimeGap;

For a downlink PRS resource in a downlink PRS resource set configured, the UE shall assume the downlink PRS resource being transmitted as described in clause 5.1.6.5 of 3GPP TS 38.214.

For sidelink CG configuration as described in 3GPP TS 38.321, there are two types of transmission without dynamic sidelink grant: configured grant Type 1 where an sidelink grant is provided by RRC, and stored as configured sidelink grant; and configured grant Type 2 where an sidelink grant is provided by physical downlink control channel (PDCCH), and stored or cleared as configured sidelink grant based on L1 signalling indicating configured sidelink grant activation or deactivation.

Type 1 and/or Type 2 are configured with a single bandwidth part (BWP). Multiple configurations of up to eight (8) configured grants (including both Type 1 and Type 2, if configured) can be active simultaneously on the BWP. RRC configures the following parameters when the configured grant Type 1 is configured, as specified in 3GPP TS 38.331 or 3GPP TS 36.331:
sl-ConfigIndexCG: the identifier of a configured grant for sidelink;
sl-CS-RNTI: sidelink configure scheduling radio network temporary identifier (SLCS-RNTI) for retransmission;
sl-NrOfHARQ-Processes: the number of HARQ processes for configured grant;
sl-PeriodCG: periodicity of the configured grant Type 1;
sl-TimeOffsetCG-Type1: Offset of a resource with respect to reference logical slot defined by sl-TimeReferenceSFN-Type1 in time domain, referring to the number of logical slots in a resource pool;
sl-TimeResourceCG-Type1: time resource location of the configured grant Type 1;
sl-CG-MaxTransNumList: the maximum number of times that a TB can be transmitted using the configured grant;
sl-HARQ-ProcID-offset: offset of HARQ process for configured grant Type 1;
sl-TimeReferenceSFN-Type1: SFN used for determination of the offset of a resource in time domain. If it is present, the UE uses the first logical slot of associated resource pool after the starting time of the closest SFN with the indicated number preceding the reception of the sidelink configured grant configuration Type 1 as reference logical slot. If it is absent, the indicated reference SFN is zero.

RRC configures the following parameters when the configured grant Type 2 is configured, as specified in 3GPP TS 38.331:
sl-ConfigIndexCG: the identifier of a configured grant for sidelink;
sl-CS-RNTI: SLCS-RNTI for activation, deactivation, and retransmission;
sl-NrOfHARQ-Processes: the number of HARQ processes for configured grant;
sl-PeriodCG: periodicity of the configured grant Type 2;
sl-CG-MaxTransNumList: the maximum number of times that a TB can be transmitted using the configured grant;
sl-HARQ-ProcID-offset: offset of HARQ process for configured grant Type 2.

Upon configuration of a configured grant Type 1, the MAC entity shall for each configured sidelink grant:
store the sidelink grant provided by RRC as a configured sidelink grant;
initialise or re-initialise the configured sidelink grant to determine physical sidelink control channel (PSCCH) duration(s) and physical sidelink shared channel (PSSCH) duration(s) according to sl-TimeOffsetCG-Type1 and sl-TimeResourceCG-Type1, and to reoccur with sl-periodCG for transmissions of multiple MAC PDUs according to clause 8.1.2 of 3GPP TS 38.214.
   Note that if the MAC entity is configured with multiple configured sidelink grants, collision among the configured sidelink grants may occur. How to handle the collision is left to UE implementation.

After a sidelink grant is configured for a configured grant Type 1, the MAC entity shall consider sequentially that the first slot of the S^{th} sidelink grant occurs in the logical slot for which:

$$CURRENT\_slot = sl - ReferenceSlotCG - Type 1 + sl - TimeOffsetCG - Type 1 + S \times PeriodicitySL ) modulo {T}_{max}^{′}$$

where CURRENT_slot refers to current logical slot in the associated resource pool,

$$PeriodicitySL = ⌈ \frac{{T}_{max}^{′}}{10240 ms} \times sl - PeriodCG ⌉$$

and T′ₘₐₓ is the number of slots that belongs to the associated resource pool as defined in clause 8 of 3GPP TS 38.214. sl-ReferenceSlotCG-Type1 refers to reference logical slot defined by sl-TimeReferenceSFN-Type1.

After a sidelink grant is configured for a configured grant Type 2, the MAC entity shall consider sequentially that the first slot of S^{th} sidelink grant occurs in the logical slot for which:

CURRENT_slot=(sl-StartSlotCG-Type2+S×PeriodicitySL)modulo T′ₘₐₓ

where sl-StartSlotCG-Type2 refers to the logical slot of the first transmission opportunity of PSSCH where the configured sidelink grant was (re)initialised.

When a configured sidelink grant is released by RRC, all the corresponding configurations shall be released and all corresponding sidelink grants shall be cleared.

The MAC entity shall:
if the configured sidelink grant confirmation has been triggered and not cancelled; and
if the MAC entity has UL resources allocated for new transmission:
   instruct the Multiplexing and Assembly procedure to generate a Sidelink Configured Grant Confirmation MAC CE as defined in clause 6.1.3.34 of 3GPP TS 38.321;
   cancel the triggered configured sidelink grant confirmation.

For a configured grant Type 2, the MAC entity shall clear the corresponding configured sidelink grant immediately after first transmission of Sidelink Configured Grant Confirmation MAC CE triggered by the configured sidelink grant deactivation.

Integrity and Reliability of the positioning estimate is defined by the following parameters:
Alert limit (AL): The maximum allowable positioning error such that the positioning system is available for the intended application. If the positioning error is beyond the AL, operations are hazardous and the positioning system should be declared unavailable for the intended application to prevent loss of integrity.
   Note that when the AL bounds the positioning error in the horizontal plane or on the vertical axis then it is called Horizontal Alert Limit (HAL) or Vertical Alert Limit (VAL) respectively.
Time to alert (TTA): The probability that the positioning error exceeds the Alert Limit (AL) without warning the user within the required Time-to-Alert (TTA).
   Note that the TIR is usually defined as a probability rate per some time unit (e.g. per hour, per second or per independent sample).
Target Integrity Risk (TIR): The maximum allowable elapsed time from when the positioning error exceeds the Alert Limit (AL) until the function providing position integrity annunciates a corresponding alert.

A UE (an initiator UE) may be allocated SL resources semi-persistently by way of a SL configured grant. Similar to NR Uu there may be two types of configured grants, type 1 and type 2 CG. SL resources are allocated with a given configured periodicity, also referred to as period. Within each period of SL CG up to three CG resources can be allocated by the base station (e.g., gNB). The HARQ process ID for each transmission in a SL resource corresponding to a SL CG is determined based on the formula used for UL configured grants in 3GGP TS 38.321.

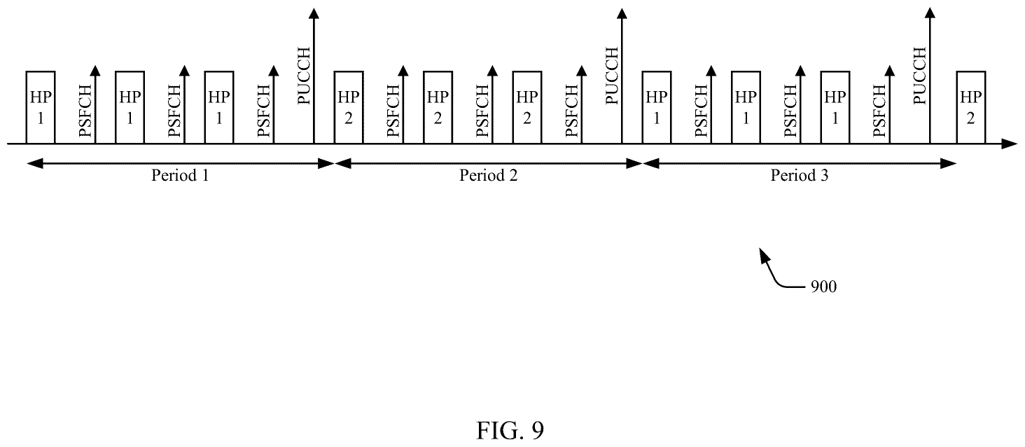

FIG. 9 shows an example 900 of a SL CG. In the example 900, three CG resources are allocated per period and two HARQ processes are used for the SL configured grant. After each CG resource a physical sidelink feedback channel (PSFCH) is allocated for the transmission of HARQ feedback from the responder (e.g., receiving) UE. After the last CG resource within a period physical uplink control channel (PUCCH) resources are allocated in order to send HARQ feedback information to the base station (e.g., gNB) indicating whether the transmission was successful or not.

Returning to FIG. 1, the techniques discussed herein support SL PRS configuration of an initiator UE 104 or a target UE 104 by a base station 102 (e.g., a gNB). The SL may be, for example, a PC5 V2X interface. The SL PRS configuration includes resource allocation methods (e.g., in V2X mode 1) that contain the SL PRS resource settings as well as the configured grant CG activation or deactivation configuration. In one or more implementations, the SL PRS configuration includes configuration of at least one of periodic SL PRS transmission, semi-persistent SL PRS transmission, or aperiodic SL PRS transmission. Additionally or alternatively, the SL PRS configuration includes configured grant configuration according to V2X mode 1 resource allocation. Additionally or alternatively, the SL PRS configuration includes reporting options for measurements based on CG and semi-persistent scheduling (SPS) SL PRS transmissions.

In the discussions herein, an initiator UE 104 initiates an SL positioning (also referred to as ranging) session. A responder UE 104 responds to the SL positioning or ranging session from the initiator UE 104.

Any one or more of the various techniques discussed herein may be implemented in combination with each other to support positioning over the SL (e.g., PC5) interface.

A positioning-related reference signal may be referred to as a reference signal used for positioning procedures or purposes in order to estimate a target UE's location, e.g., based on PRS, or based on existing reference signals such as channel state information reference signal (CSI-RS) or SRS. A target UE may be referred to as the device or entity to be localized or positioned. In various embodiments, the term ‘PRS’ may refer to any signal such as a reference signal, which may or may not be used primarily for positioning.

A target UE may be referred to as a UE of interest whose position (absolute or relative) is to be obtained by the network or by the UE itself. The target UE may be, for example, an initiator UE or a responder UE.

In one or more implementations, the SL PRS transmission is periodic, semi-persistent, or aperiodic. Periodic SL PRS transmission refers to SL PRS transmission continuing at a regular set periodic rate. Semi-persistent SL PRS transmission refers to SL PRS transmission at a regular set periodic rate, but which can be activated and deactivated as desired (e.g., by the base station 102). Aperiodic SL PRS transmission refers to SL PRS transmission at irregular intervals (e.g., as indicated in a MAC CE or SCI). Semi-static signaling, e.g., received from a base station 102, configures a PRS resource set to SL UEs when requested for positioning resources. There can be any number ‘N’ of PRS resources in each PRS resource set.

In one or more implementations, a periodic SL PRS configuration is semi-statically configured to transmit SL PRS in every Nth slot periodicity using the configured comb pattern, base sequence, cyclic shift, symbol length, symbol offset from the slot boundary, slot offset from system frame number/direct frame number (SFN/DFN). The configuration of comb pattern, base sequence, cyclic shift, PRS resource set and PRS resource in a resource set depends on the type of PRS sequence used which could be, for example, a Gold sequence or a Zadoff-Chu sequence). A PRS resource in a PRS resource set can be activated or deactivated by various signaling, such as RRC signaling. PC5 RRC signaling may be used by the initiator ULE 104 to signal the periodic SL PRS configuration, activation, or deactivation to the responder UE 104. However, the initiator ULE may acquire the periodic SL PRS configuration from the base station 102 using semi-static signaling.

In one or more implementations, a semi-persistent SL PRS configuration is semi-statically configured to transmit SL PRS very similar to periodic SL PRS transmission. However, the activation or deactivation may be transmitted using a MAC CE, the MAC CE may contain a field to activate a single PRS resource in a resource set, and so forth. Once the semi-persistent SL PRS transmission has been activated, the device can assume that the semi-persistent SL PRS transmission will continue according to the configured periodicity until it is explicitly deactivated. Similarly, once the semi-persistent SL PRS transmission has been deactivated, the device can assume that there will be no semi-persistent SL PRS transmissions according to the configuration until it is explicitly re-activated. A PRS resource indicator defining the PRS resource in a PRS resource set for semi-persistent SL PRS configuration is signaled, for example, in the DCI.

In one or more implementations, an aperiodic SL PRS is semi-statically configured to transmit SL PRS very similar to the above procedure for semi-persistent SL PRS except that the PRS request indicator can be transmitted in at least one of a MAC CE or SCI. A PRS resource indicator defining the PRS resource in a PRS resource set may be signaled to the initiator UE 104 in at least one of the DCI or SCI.

In one or more implementations, the base station 102 provides multiple SL CG type 1 and SL CG type 2 configurations for the SL PRS transmission where the SL CG type 1 and SL CG type 2 can be configured within the SL positioning frequency layer (PFL). This is beneficial, for example, for periodic location information (e.g., absolute or relative) transfer. There could be multiple of up to ‘N’ configured grants (including both Type 1 and Type 2, if configured) active simultaneously on these SL PFL. These CG configuration for SL positioning within SL PFL may be defined separately compared to the SL data.

The RRC separately configures the SL CG type 1 and SL CG type 2 for positioning and some parameters may be different compared to SL CG type 1 and SL CG type 2 for SL data. Since there is no need to have HARQ processing for SL PRS transmission, parameters related to HARQ processes, etc., may not be needed for SL CG type 1 and SL CG type 2. However new parameters defining SL CG for SL PRS transmission may include, for example, time resource, frequency resource, base sequence, cyclic shifts for PRS transmission with Zadoff-Chu sequence, and so forth.

In one example, for a SL OTDoA positioning method, where at least three anchor nodes are used, a CG configuration for SL PRS may be associated with different beams associated with different anchor and/or target UEs. The UE might in this case, measure the SL PRS received signal time difference (RSTD) per beam or resource. The SL PRS resource could be repeated in order to collect more measurements and improve the positioning accuracy. The SL PRS resource or beam can be repeated up to ‘K’ times per SL capable device involved in the positioning. The repetition of resources can be done in two ways: repeat before sweep or sweep before repeat. Additionally or alternatively, a CG configuration can be associated with one SL PRS resource or beam and the SL PRS resource repetitions. The amount and type of repetition can be configured with parameters for configuring the gaps between resources and the number of resource repetitions within a period of resource set.

In one or more implementations, in a SL period a SL PRS transmission to a destination ID or ranging ID may be repeated according to a maximum repetition within the end of the SL period and the repetition does not span across the period. With every new period, the SL PRS transmission may be transmitted to a new destination ID or ranging ID. The initiator UE may transmit SL PRS with PRS repetition factor in the PRS resources configured within a period to one or more anchor UEs for the TDOA technique. Additionally or alternatively, anchor UEs may transmit SL PRS towards the target UE in the PRS resources configured within a period by associating each PRS repetition with an anchor UE. A new RNTI may be defined to activate or deactivate the CG type 2 resource for SL PRS.

In one or more implementations, validation of a DCI format (e.g., DCI format 3_x) for SL CG type 2 transmitting SL PRS is achieved if all fields for the DCI format are set according to the tables below.

If validation is achieved, the UE considers the information in the DCI format as a valid activation or valid release (e.g., deactivation) of SL configured grant Type 2. If validation is not achieved, the UE discards all the information in the DCI format.

Table T7 shows the special fields for SL PRS configured grant Type 2 scheduling activation PDCCH validation.

TABLE T7

| | DCI format 3_x |
|---|---|
| Time/frequency assignment | set to all ‘0’s |
| Cyclic shift | set to all ‘0’s |

Table T8 shows the special fields for SL PRS configured grant Type 2 scheduling release (e.g., deactivation) PDCCH validation.

TABLE T8

| | DCI format 3_x |
|---|---|
| Cyclic shift | set to all ‘1’s |
| Frequency resource | set to all ‘1’s |
| assignment (if present) | |

In one or more implementations, the base station 102 configures the SL positioning resources for each of the SL positioning quality of service (QoS) using the RRC common signaling. These SL positioning resources may be defined as SL CG type 1 using the RRC signaling and there could be multiple SL CG type 1 resources configured, each tailored to satisfy the QoS configuration for SL positioning.

In one or more implementations, an initiator UE configured with a periodic or semi-persistent SL PRS transmission may transmit an applicable reporting configuration to the responder UE. The reporting configuration details the type of reporting required, based on SL RAT-dependent measurements, which are in turn derived from the periodic and semi-persistent transmissions described above, and performed at the responder UE side.

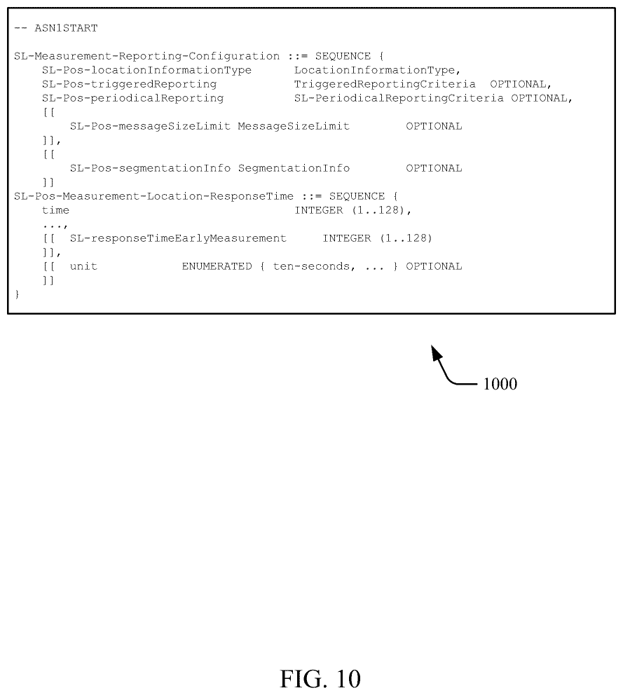

FIG. 10 illustrates an example 1000 of configuration parameters that may be signaled to the responder UE as related to configuring sidelink positioning reference signals transmission, as described herein. The example 1000 illustrates several measurement reporting configurations, one or more of which may be included in a reporting configuration sent by the initiator UE to the responder UE. The example 1000 includes one or more of a location information type (SL-Pos-locationInformationType), triggered reporting information (SL-Pos-triggeredReporting), periodic reporting information (SL-Pos-periodicalReporting), message size limit information (SL-Pos-messageSizeLimit), segmentation information (SL-Pos-segmentationInfo), a measurement response time (SL-Pos-Measurement-Location-ResponseTime), and an early measurement response time (SL-responseTimeEarlyMeasurement).

In one or more implementations, the SL-Pos-locationInformationType IE indicates whether the initiator UE requires a location estimate or measurements. For ‘locationEstimateRequired’, the responder device shall return an absolute or relative location estimate if possible, or indicate a location error if not possible. For ‘locationMeasurementsRequired’, the target (e.g., responder) device shall return measurements if possible, or indicate a location error if not possible. Additionally or alternatively, a further indication may be indicated if the reported measurements are periodic or semi-persisitent. For ‘locationEstimatePreferred’, the target (e.g., responder) device shall return an absolute or relative location estimate if possible, but may also or instead return measurements for any requested position methods for which a location estimate is not possible. For ‘locationMeasurementsPreferred’, the target (e.g., responder) device shall return location measurements if possible, but may also or instead return a location estimate for any requested position methods for which return of location measurements is not possible.

In one or more implementations, the SL-Pos-triggeredReporting IE indicates that triggered SL reporting is requested and includes the SLreportingDuration subfield. The SLreportingDuration subfield is a maximum duration of triggered reporting in seconds. A value of zero is interpreted to mean an unlimited (e.g., “infinite”) duration. The responder device is to continue triggered reporting for the reportingDuration or until an SL positioning Abort or Error message is received. This may be based on periodical and semi-persistent SL PRS transmissions.

In one or more implementations, the SL-Pos-periodicalReporting IE indicates that periodic reporting is requested and includes a SL-Pos-reportingAmount and a SL-Pos-reportingInterval subfield. The SL-Pos-reportingAmount subfield indicates the number of SL positioning periodic location information reports requested. Enumerated values correspond to 1, 2, 4, 8, 16, 32, 64, or infinite/indefinite number of reports. If the reportingAmount is ‘infinite indefinite’, the responding device is to continue periodic reporting until an SL positioning Abort message is received. The value ‘ral’ is not to be used by a sender. The SL-Pos-reportingInterval subfield indicates the interval between location information reports and the response time requirement for the first sidelink location information report. Enumerated values ri0-25, ri0-5, ri1, ri2, ri4, ri8, ri16, ri32, ri64 correspond to reporting intervals of 1, 2, 4, 8, 10, 16, 20, 32, and 64 seconds, respectively. Measurement reports containing no measurements or no location estimate are used when a reportingInterval expires before a target device is able to obtain new measurements or obtain a new location estimate. The value ‘noPeriodicalReporting’ is not to be used by an initiator UE. Additionally or alternatively, the periodical reports may align with the configured SL PRS CG/SPS periodicities for low latency reporting in the order of slot duration/ms.

In one or more implementations, the SL-Pos-messageSizeLimit field provides an octet limit on the amount of location information a target (e.g., responder) device can return. The measurementLimit field indicates the maximum amount of location information the target device should return in response to the SL-Reporting-Configuration message received from the initiator UE. The limit applies to the overall size of the SL positioning message size, which may apply to a higher SL positioning protocol e.g., SL LTE positioning protocol (LPP) message at SL LPP level or PC5 RRC, and is specified in steps of 100 octets. The message size limit is then given by the value provided in measurementLimit times 100 octets.

In one or more implementations, the SL-Pos-segmentationInfo field indicates whether SL-Reporting-Configuration message is one of many segments, as specified in clause 4.3.5 of 3GPP TS 37.355. This implementation uses the CG grant provided by the network, e.g., if the amount of resources provided by CG grant provided by the network is less than the reporting message size to be transmitted, then the initiator UE may configure a segmentation indication.

In one or more implementations, the SL-Pos-Measurement-Location-ResponseTime IE includes a time field and a unit field. The time field indicates the maximum response time as measured between receipt of the SL reporting configuration and transmission of the SL measurement report. If the unit field is absent, this is given as an integer number of seconds between 1 and 128. If the unit field is present, the maximum response time is given in units of 10-seconds, between 10 and 1280 seconds. If the periodicalReporting IE is included in the SL reporting configuration, this field is not to be included. Additionally or alternatively, response time may be set according to the planned deactivation of the CG/SPS SL PRS transmission. The unit field indicates the unit of the time in which SL response time is to be provided.

In one or more implementations, the responder device transmits measurement reports to the LMF or the base station 102. In this situation, the report can be either semi-persistent or aperiodic. According to a semi-persistent reporting configuration, SL PRS reporting can be transmitted on PUCCH to the base station 102 or over LPP signaling to the LMF, and in this case it could be triggered by a MAC CE. Additionally or alternatively, SL PRS reporting can be transmitted over physical uplink shared channel (PUSCH) and in this case triggered by DCI.

According to an aperiodic reporting configuration, SL PRS reporting can be triggered by a MAC CE and in another implementation by DCI.

Additionally or alternatively, reporting can be periodic in the case of a periodic SL PRS resource configuration. The periodicity can be defined and signaled to the initiator UE by the network (e.g., the base station 102).

Thus, using the techniques discussed herein, SL can be used for PRS in addition to supporting periodic and semi-persistent transmissions for data packets to support applications including safety critical cooperative awareness (CAM) and decentralized environmental notification (DENM) messages as well as the advanced V2X use cases. For example, with V2X it is important for each vehicle to constantly be aware of the surrounding vehicles via the relative positioning estimation as well as orientation/relative direction. Periodic and semi-persistent SL PRS transmissions can resolve this issue, and the techniques discussed herein describe a mechanism to support such frequent transmission between the initiator UE and responder UE. Described herein are apparatuses, methods and systems, detailing the configuration of periodic and semi-persistent SL PRS transmissions between an initiator device and responding device. In addition, associated reporting options of periodic or semi-persistent SL PRS measurements are also provided.

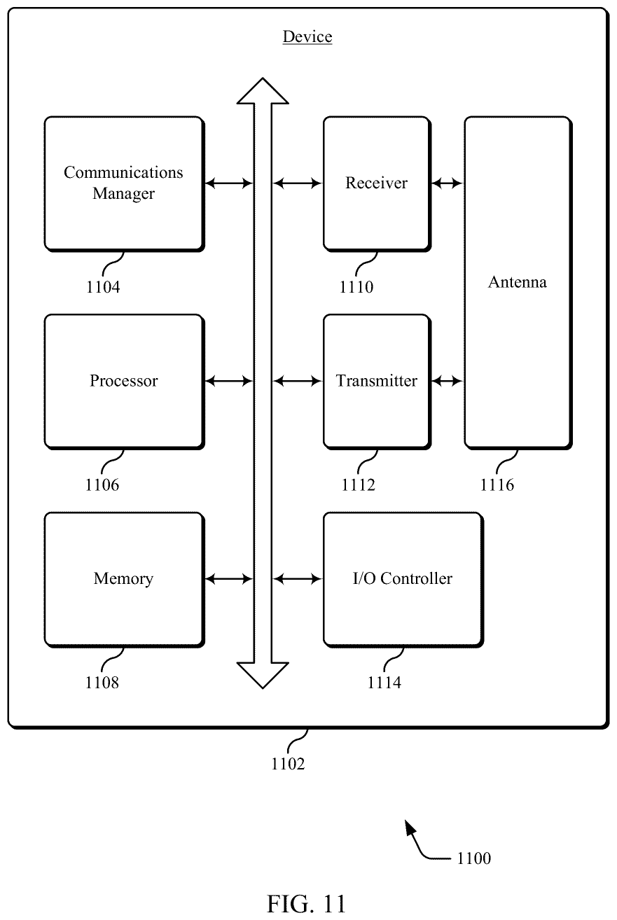

FIG. 11 illustrates an example of a block diagram 1100 of a device 1102 that supports configuring sidelink positioning reference signals transmission in accordance with aspects of the present disclosure. The device 1102 may be an example of a ULE 104 as described herein, including an initiator UE 118 or a responder UE 122. The device 1102 may support wireless communication and/or network signaling with one or more base stations 102, other UEs 104, network entities and devices, or any combination thereof. The device 1102 may include components for bi-directional communications including components for transmitting and receiving communications, such as a communications manager 1104, a processor 1106, a memory 1108, a receiver 1110, a transmitter 1112, and an I/O controller 1114. These components may be in electronic communication or otherwise coupled (e.g., operatively, communicatively, functionally, electronically, electrically) via one or more interfaces (e.g., buses).

The communications manager 1104, the receiver 1110, the transmitter 1112, or various combinations thereof or various components thereof may be examples of means for performing various aspects of the present disclosure as described herein. For example, the communications manager 1104, the receiver 1110, the transmitter 1112, or various combinations or components thereof may support a method for performing one or more of the functions described herein.

In some implementations, the communications manager 1104, the receiver 1110, the transmitter 1112, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 1106 and the memory 1108 coupled with the processor 1106 may be configured to perform one or more of the functions described herein (e.g., by executing, by the processor 1106, instructions stored in the memory 1108).

Additionally or alternatively, in some implementations, the communications manager 1104, the receiver 1110, the transmitter 1112, or various combinations or components thereof may be implemented in code (e.g., as communications management software or firmware) executed by the processor 1106. If implemented in code executed by the processor 1106, the functions of the communications manager 1104, the receiver 1110, the transmitter 1112, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some implementations, the communications manager 1104 may be configured to perform various operations (e.g., receiving, monitoring, transmitting) using or otherwise in cooperation with the receiver 1110, the transmitter 1112, or both. For example, the communications manager 1104 may receive information from the receiver 1110, send information to the transmitter 1112, or be integrated in combination with the receiver 1110, the transmitter 1112, or both to receive information, transmit information, or perform various other operations as described herein. Although the communications manager 1104 is illustrated as a separate component, in some implementations, one or more functions described with reference to the communications manager 1104 may be supported by or performed by the processor 1106, the memory 1108, or any combination thereof. For example, the memory 1108 may store code, which may include instructions executable by the processor 1106 to cause the device 1102 to perform various aspects of the present disclosure as described herein, or the processor 1106 and the memory 1108 may be otherwise configured to perform or support such operations.

For example, the communications manager 1104 may support wireless communication and/or network signaling at a device (e.g., the device 1102, a UE) in accordance with examples as disclosed herein. The communications manager 1104 and/or other device components may be configured as or otherwise support an apparatus, such as a UE, including a transceiver; a processor coupled to the transceiver, the processor and the transceiver configured to cause the apparatus to: receive, from a network node, a first control signaling indicating transmission of SL PRS by the apparatus in at least one of a periodic manner, a semi-persistent manner, or an aperiodic manner; and transmit, to a responder UE, a second control signaling including SL PRS based at least in part on the received first control signaling.

Additionally, the apparatus (e.g., a UE) includes any one or combination of: where the network node comprises a base station; where the first control signaling indicates transmission of SL PRS by the apparatus in the semi-persistent manner, and the processor and the transceiver are further configured to cause the apparatus to: receive, from the network node, a third control signaling indicating to activate transmission of SL PRS by the apparatus in the semi-persistent manner; and initiate, in response to the third control signaling, transmission of SL PRS by the apparatus to the responder UE in the semi-persistent manner; where the processor and the transceiver are further configured to cause the apparatus to: receive, from the network node, a fourth control signaling indicating to deactivate transmission of SL PRS by the apparatus in the semi-persistent manner; and cease, in response to the fourth control signaling, transmission of SL PRS by the apparatus in the semi-persistent manner; where the processor and the transceiver are further configured to cause the apparatus to: transmit, to the responder UE, a third control signaling indicating SL PRS transmission in at least one of the periodic, the semi-persistent, or the aperiodic manner based on the first control signaling; and receive, from the responder UE and based at least in part on the third control signaling, a fourth control signaling indicating a PRS measurement; where the processor and the transceiver are further configured to cause the apparatus to: receive, from the network node, a third control signaling indicating a CG configuration within a positioning frequency layer corresponding to a positioning resource set; and transmit the second control signaling within a CG resource indicated by the CG configuration; where the processor and the transceiver are further configured to cause the apparatus to: receive, from the network node, a third control signaling indicating activation or deactivation of a CG resource for the SL PRS, the third control signaling further indicating a positioning resource identifier within a positioning resource set; and activate or deactivate, in accordance with the third control signaling, the CG resource for the SL PRS; where the third control signaling comprises a DCI signaling; where the processor and the transceiver are further configured to cause the apparatus to: receive, from the network node, a third control signaling indicating one or more of a periodic positioning resource for transmitting the second control signaling, a semi-persistent positioning resource for transmitting the second control signaling, or an aperiodic positioning resource for transmitting the second control signaling; and transmit the second control signaling using the indicated one or more of the periodic positioning resource, the semi-persistent positioning resource, and the aperiodic positioning resource; where the processor and the transceiver are further configured to cause the apparatus to: receive, from the network node, a fourth control signaling indicating activation or deactivation of a positioning resource within a positioning resource set for the SL PRS; and activate or deactivate, in accordance with the fourth control signaling, the positioning resource for the SL PRS.

Additionally or alternatively, the communications manager 1104 and/or other device components may be configured as or otherwise support an apparatus, such as a UE, including a transceiver; a processor coupled to the transceiver, the processor and the transceiver configured to cause the apparatus to: receive, from an initiator user equipment (UE), a first control signaling including sidelink (SL) positioning reference signals (PRS) in at least one of a periodic manner, a semi-persistent manner, or an aperiodic manner; receive, from the initiator UE, a second control signaling indicating SL PRS transmission in at least one of the periodic, the semi-persistent, or the aperiodic manner based on the first control signaling; and transmit, to the initiator UE and based at least in part on the second control signaling, a third control signaling indicating a PRS measurement.

Additionally, the apparatus (e.g., a UE) includes any one or combination of: receive the first control signaling within a CG configuration within a positioning frequency layer corresponding to a positioning resource set.

The communications manager 1104 and/or other device components may be configured as or otherwise support a means for wireless communication and/or network signaling at a UE, including receiving, from a network node, a first control signaling indicating transmission of SL PRS by the UE in at least one of a periodic manner, a semi-persistent manner, or an aperiodic manner; and transmitting, to a responder UE, a second control signaling including SL PRS based at least in part on the received first control signaling.

Additionally, wireless communication and/or network signaling at the UE includes any one or combination of: where the network node comprises a base station; where the first control signaling indicates transmission of SL PRS by the UE in the semi-persistent manner, and the method further comprises: receiving, from the network node, a third control signaling indicating to activate transmission of SL PRS by the UE in the semi-persistent manner; and initiating, in response to the third control signaling, transmission of SL PRS by the UE to the responder UE in the semi-persistent manner; further including: receiving, from the network node, a fourth control signaling indicating to deactivate transmission of SL PRS by the UE in the semi-persistent manner; and ceasing, in response to the fourth control signaling, transmission of SL PRS by the UE in the semi-persistent manner; further including: transmitting, to the responder UE, a third control signaling indicating SL PRS transmission in at least one of the periodic, the semi-persistent, or the aperiodic manner based on the first control signaling; and receiving, from the responder UE and based at least in part on the third control signaling, a fourth control signaling indicating a PRS measurement; further including: receiving, from the network node, a third control signaling indicating a CG configuration within a positioning frequency layer corresponding to a positioning resource set; and transmitting the second control signaling within a CG resource indicated by the CG configuration; further including: receiving, from the network node, a third control signaling indicating activation or deactivation of a CG resource for the SL PRS, the third control signaling further indicating a positioning resource identifier within a positioning resource set; and activating or deactivating, in accordance with the third control signaling, the CG resource for the SL PRS; where the third control signaling comprises a DCI signaling; further including: receiving, from the network node, a third control signaling indicating one or more of a periodic positioning resource for transmitting the second control signaling, a semi-persistent positioning resource for transmitting the second control signaling, or an aperiodic positioning resource for transmitting the second control signaling; and transmitting the second control signaling using the indicated one or more of the periodic positioning resource, the semi-persistent positioning resource, and the aperiodic positioning resource; receiving, from the network node, a fourth control signaling indicating activation or deactivation of a positioning resource within a positioning resource set for the SL PRS; and activating or deactivating, in accordance with the fourth control signaling, the positioning resource for the SL PRS.

Additionally or alternatively, the communications manager 1104 and/or other device components may be configured as or otherwise support a means for wireless communication and/or network signaling at a UE, including receiving, from an initiator UE, a first control signaling including SL PRS in at least one of a periodic manner, a semi-persistent manner, or an aperiodic manner; receiving, from the initiator UE, a second control signaling indicating SL PRS transmission in at least one of the periodic, the semi-persistent, or the aperiodic manner based on the first control signaling; and transmitting, to the initiator UE and based at least in part on the second control signaling, a third control signaling indicating a PRS measurement.

Additionally, wireless communication and/or network signaling at the UE includes any one or combination of: receiving the first control signaling within a CG configuration within a positioning frequency layer corresponding to a positioning resource set.

The processor 1106 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 1106 may be configured to operate a memory array using a memory controller. In some other implementations, a memory controller may be integrated into the processor 1106. The processor 1106 may be configured to execute computer-readable instructions stored in a memory (e.g., the memory 1108) to cause the device 1102 to perform various functions of the present disclosure.

The memory 1108 may include random access memory (RAM) and read-only memory (ROM). The memory 1108 may store computer-readable, computer-executable code including instructions that, when executed by the processor 1106 cause the device 1102 to perform various functions described herein. The code may be stored in a non-transitory computer-readable medium such as system memory or another type of memory. In some implementations, the code may not be directly executable by the processor 1106 but may cause a computer (e.g., when compiled and executed) to perform functions described herein. In some implementations, the memory 1108 may include, among other things, a basic I/O system (BIOS) which may control basic hardware or software operation such as the interaction with peripheral components or devices.

The I/O controller 1114 may manage input and output signals for the device 1102. The I/O controller 1114 may also manage peripherals not integrated into the device 1102. In some implementations, the I/O controller 1114 may represent a physical connection or port to an external peripheral. In some implementations, the I/O controller 1114 may utilize an operating system such as iOS®, ANDROID®, MS-DOS®, MS-WINDOWS®, OS/2®, UNIX®, LINUX®, or another known operating system. In some implementations, the I/O controller 1114 may be implemented as part of a processor, such as the processor 1106. In some implementations, a user may interact with the device 1102 via the I/O controller 1114 or via hardware components controlled by the I/O controller 1114.

In some implementations, the device 1102 may include a single antenna 1116. However, in some other implementations, the device 1102 may have more than one antenna 1116, which may be capable of concurrently transmitting or receiving multiple wireless transmissions. The receiver 1110 and the transmitter 1112 may communicate bi-directionally, via the one or more antennas 1116, wired, or wireless links as described herein. For example, the receiver 1110 and the transmitter 1112 may represent a wireless transceiver and may communicate bi-directionally with another wireless transceiver. The transceiver may also include a modem to modulate the packets, to provide the modulated packets to one or more antennas 1116 for transmission, and to demodulate packets received from the one or more antennas 1116.

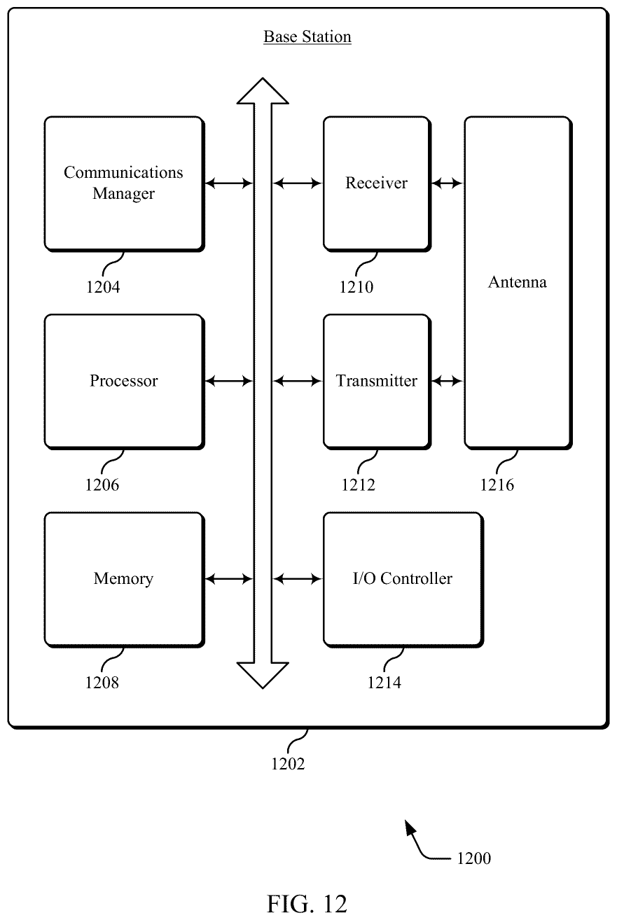

FIG. 12 illustrates an example of a block diagram 1200 of a device 1202 that supports configuring sidelink positioning reference signals transmission in accordance with aspects of the present disclosure. The device 1202 may be an example of a base station 102, such as a gNB as described herein. The device 1202 may support wireless communication and/or network signaling with one or more base stations 102, other UEs 104, core network devices and functions (e.g., core network 106), or any combination thereof. The device 1202 may include components for bi-directional communications including components for transmitting and receiving communications, such as a communications manager 1204, a processor 1206, a memory 1208, a receiver 1210, a transmitter 1212, and an I/O controller 1214. These components may be in electronic communication or otherwise coupled (e.g., operatively, communicatively, functionally, electronically, electrically) via one or more interfaces (e.g., buses).

The communications manager 1204, the receiver 1210, the transmitter 1212, or various combinations thereof or various components thereof may be examples of means for performing various aspects of the present disclosure as described herein. For example, the communications manager 1204, the receiver 1210, the transmitter 1212, or various combinations or components thereof may support a method for performing one or more of the functions described herein.

In some implementations, the communications manager 1204, the receiver 1210, the transmitter 1212, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 1206 and the memory 1208 coupled with the processor 1206 may be configured to perform one or more of the functions described herein (e.g., by executing, by the processor 1206, instructions stored in the memory 1208).

Additionally or alternatively, in some implementations, the communications manager 1204, the receiver 1210, the transmitter 1212, or various combinations or components thereof may be implemented in code (e.g., as communications management software or firmware) executed by the processor 1206. If implemented in code executed by the processor 1206, the functions of the communications manager 1204, the receiver 1210, the transmitter 1212, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some implementations, the communications manager 1204 may be configured to perform various operations (e.g., receiving, monitoring, transmitting) using or otherwise in cooperation with the receiver 1210, the transmitter 1212, or both. For example, the communications manager 1204 may receive information from the receiver 1210, send information to the transmitter 1212, or be integrated in combination with the receiver 1210, the transmitter 1212, or both to receive information, transmit information, or perform various other operations as described herein. Although the communications manager 1204 is illustrated as a separate component, in some implementations, one or more functions described with reference to the communications manager 1204 may be supported by or performed by the processor 1206, the memory 1208, or any combination thereof. For example, the memory 1208 may store code, which may include instructions executable by the processor 1206 to cause the device 1202 to perform various aspects of the present disclosure as described herein, or the processor 1206 and the memory 1208 may be otherwise configured to perform or support such operations.

For example, the communications manager 1204 may support wireless communication and/or network signaling at a device (e.g., the device 1202, a base station) in accordance with examples as disclosed herein. The communications manager 1204 and/or other device components may be configured as or otherwise support an apparatus, such as a base station, including a transceiver; a processor coupled to the transceiver, the processor and the transceiver configured to cause the apparatus to: transmit, to a UE, a first control signaling indicating transmission of SL PRS by the UE in at least one of a periodic manner, a semi-persistent manner, or an aperiodic manner; and transmit, to the UE, a second control signaling indicating one or more of a periodic positioning resource for transmitting the second control signaling, a semi-persistent positioning resource for transmitting the second control signaling, or an aperiodic positioning resource for transmitting the second control signaling.

Additionally, the apparatus (e.g., abase station) includes any one or combination of: where the apparatus comprises a base station; where the first control signaling indicates transmission of SL PRS by the UE in the semi-persistent manner, and the processor and the transceiver are further configured to cause the apparatus to: transmit, to the UE, a third control signaling indicating to activate transmission of SL PRS by the UE in the semi-persistent manner; where the processor and the transceiver are further configured to cause the apparatus to: transmit, to the UE, a fourth control signaling indicating to deactivate transmission of SL PRS by the UE in the semi-persistent manner; where the processor and the transceiver are further configured to cause the apparatus to: transmit, to the UE, a third control signaling indicating, for the SL PRS, a CG configuration within a positioning frequency layer corresponding to a positioning resource set; where the processor and the transceiver are further configured to cause the apparatus to: transmit, to the UE, a third control signaling indicating activation or deactivation of a CG resource for the SL PRS, the third control signaling further indicating a positioning resource identifier within a positioning resource set; where the third control signaling comprises a DCI signaling; where the processor and the transceiver are further configured to cause the apparatus to: transmit, to the UE, a fourth control signaling indicating activation or deactivation of a positioning resource within a positioning resource set for the SL PRS.

The communications manager 1204 and/or other device components may be configured as or otherwise support a means for wireless communication and/or network signaling at a base station, including transmitting, to a UE, a first control signaling indicating transmission of SL PRS by the UE in at least one of a periodic manner, a semi-persistent manner, or an aperiodic manner; and transmitting, to the UE, a second control signaling indicating one or more of a periodic positioning resource for transmitting the second control signaling, a semi-persistent positioning resource for transmitting the second control signaling, or an aperiodic positioning resource for transmitting the second control signaling.

Additionally, wireless communication at the base station includes any one or combination of: where the method is implemented at a base station; where the first control signaling indicates transmission of SL PRS by the UE in the semi-persistent manner, and the method further comprises: transmitting, to the UE, a third control signaling indicating to activate transmission of SL PRS by the UE in the semi-persistent manner; further including: transmitting, to the UE, a fourth control signaling indicating to deactivate transmission of SL PRS by the UE in the semi-persistent manner; further including: transmitting, to the UE, a third control signaling indicating, for the SL PRS, a CG configuration within a positioning frequency layer corresponding to a positioning resource set; further including: transmitting, to the UE, a third control signaling indicating activation or deactivation of a CG resource for the SL PRS, the third control signaling further indicating a positioning resource identifier within a positioning resource set; where the third control signaling comprises a DCI signaling; further including: transmitting, to the UE, a fourth control signaling indicating activation or deactivation of a positioning resource within a positioning resource set for the SL PRS.

The processor 1206 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 1206 may be configured to operate a memory array using a memory controller. In some other implementations, a memory controller may be integrated into the processor 1206. The processor 1206 may be configured to execute computer-readable instructions stored in a memory (e.g., the memory 1208) to cause the device 1202 to perform various functions of the present disclosure.

The memory 1208 may include random access memory (RAM) and read-only memory (ROM). The memory 1208 may store computer-readable, computer-executable code including instructions that, when executed by the processor 1206 cause the device 1202 to perform various functions described herein. The code may be stored in a non-transitory computer-readable medium such as system memory or another type of memory. In some implementations, the code may not be directly executable by the processor 1206 but may cause a computer (e.g., when compiled and executed) to perform functions described herein. In some implementations, the memory 1208 may include, among other things, a basic I/O system (BIOS) which may control basic hardware or software operation such as the interaction with peripheral components or devices.

The I/O controller 1214 may manage input and output signals for the device 1202. The I/O controller 1214 may also manage peripherals not integrated into the device 1202. In some implementations, the I/O controller 1214 may represent a physical connection or port to an external peripheral. In some implementations, the I/O controller 1214 may utilize an operating system such as iOS®, ANDROID®, MS-DOS®, MS-WINDOWS®, OS/2®, UNIX®, LINUX®, or another known operating system. In some implementations, the I/O controller 1214 may be implemented as part of a processor, such as the processor 1206. In some implementations, a user may interact with the device 1202 via the I/O controller 1214 or via hardware components controlled by the I/O controller 1214.

In some implementations, the device 1202 may include a single antenna 1216. However, in some other implementations, the device 1202 may have more than one antenna 1216, which may be capable of concurrently transmitting or receiving multiple wireless transmissions. The receiver 1210 and the transmitter 1212 may communicate bi-directionally, via the one or more antennas 1216, wired, or wireless links as described herein. For example, the receiver 1210 and the transmitter 1212 may represent a wireless transceiver and may communicate bi-directionally with another wireless transceiver. The transceiver may also include a modem to modulate the packets, to provide the modulated packets to one or more antennas 1216 for transmission, and to demodulate packets received from the one or more antennas 1216.

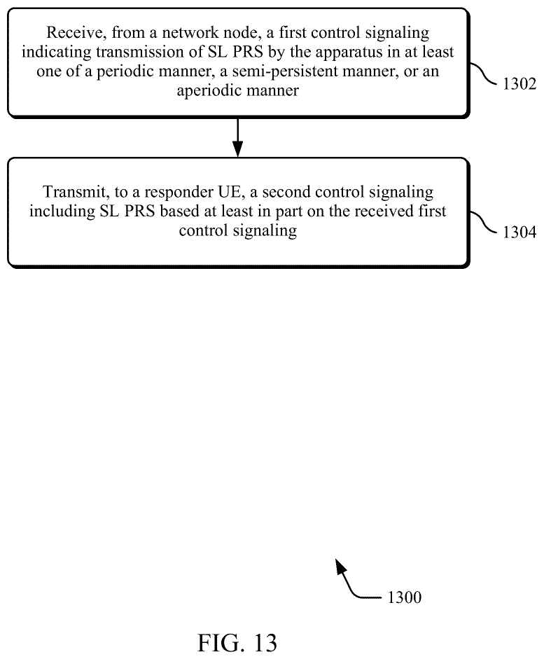

FIG. 13 illustrates a flowchart of a method 1300 that supports configuring sidelink positioning reference signals transmission in accordance with aspects of the present disclosure. The operations of the method 1300 may be implemented and performed by a device or its components, such as a UE 104 as described with reference to FIGS. 1 through 12. In some implementations, the device may execute a set of instructions to control the function elements of the device to perform the described functions. Additionally, or alternatively, the device may perform aspects of the described functions using special-purpose hardware.

At 1302, the method may include receiving, from a network node, a first control signaling indicating transmission of SL PRS by the apparatus in at least one of a periodic manner, a semi-persistent manner, or an aperiodic manner. The operations of 1302 may be performed in accordance with examples as described herein. In some implementations, aspects of the operations of 1302 may be performed by a device as described with reference to FIG. 1.

At 1304, the method may include transmitting, to a responder UE, a second control signaling including SL PRS based at least in part on the received first control signaling. The operations of 1304 may be performed in accordance with examples as described herein. In some implementations, aspects of the operations of 1304 may be performed by a device as described with reference to FIG. 1.

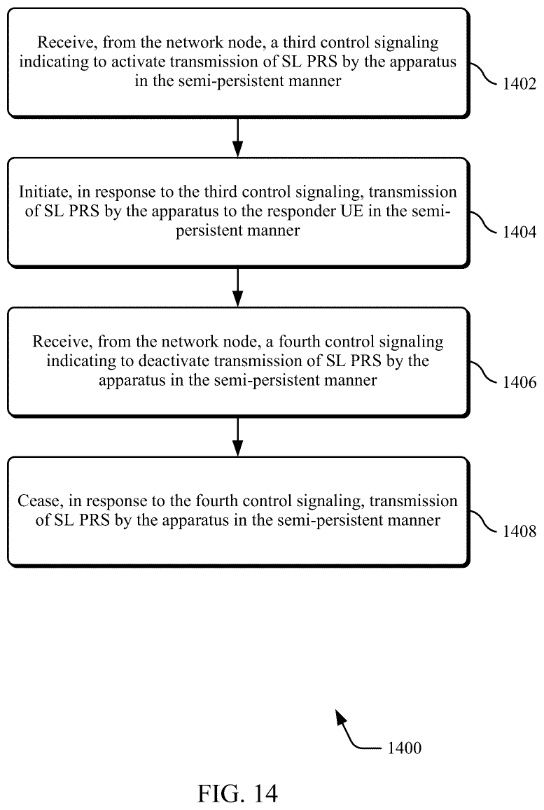

FIG. 14 illustrates a flowchart of a method 1400 that supports configuring sidelink positioning reference signals transmission in accordance with aspects of the present disclosure. The operations of the method 1400 may be implemented and performed by a device or its components, such as a UE 104 as described with reference to FIGS. 1 through 12. In some implementations, the device may execute a set of instructions to control the function elements of the device to perform the described functions. Additionally, or alternatively, the device may perform aspects of the described functions using special-purpose hardware.

At 1402, the method may include receiving, from the network node, a third control signaling indicating to activate transmission of SL PRS by the apparatus in the semi-persistent manner. The operations of 1402 may be performed in accordance with examples as described herein. In some implementations, aspects of the operations of 1402 may be performed by a device as described with reference to FIG. 1.

At 1404, the method may include initiating, in response to the third control signaling, transmission of SL PRS by the apparatus to the responder UE in the semi-persistent manner. The operations of 1404 may be performed in accordance with examples as described herein. In some implementations, aspects of the operations of 1404 may be performed by a device as described with reference to FIG. 1.

At 1406, the method may include receiving, from the network node, a fourth control signaling indicating to deactivate transmission of SL PRS by the apparatus in the semi-persistent manner. The operations of 1406 may be performed in accordance with examples as described herein. In some implementations, aspects of the operations of 1406 may be performed by a device as described with reference to FIG. 1.

At 1408, the method may include ceasing, in response to the fourth control signaling, transmission of SL PRS by the apparatus in the semi-persistent manner. The operations of 1408 may be performed in accordance with examples as described herein. In some implementations, aspects of the operations of 1408 may be performed by a device as described with reference to FIG. 1.

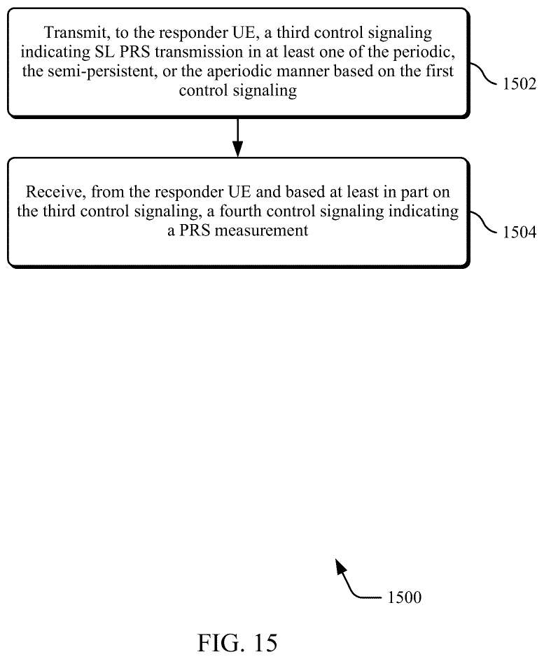

FIG. 15 illustrates a flowchart of a method 1500 that supports configuring sidelink positioning reference signals transmission in accordance with aspects of the present disclosure. The operations of the method 1500 may be implemented and performed by a device or its components, such as a UE 104 as described with reference to FIGS. 1 through 12. In some implementations, the device may execute a set of instructions to control the function elements of the device to perform the described functions. Additionally, or alternatively, the device may perform aspects of the described functions using special-purpose hardware.

At 1502, the method may include transmitting, to the responder UE, a third control signaling indicating SL PRS transmission in at least one of the periodic, the semi-persistent, or the aperiodic manner based on the first control signaling. The operations of 1502 may be performed in accordance with examples as described herein. In some implementations, aspects of the operations of 1502 may be performed by a device as described with reference to FIG. 1.

At 1504, the method may include receiving, from the responder UE and based at least in part on the third control signaling, a fourth control signaling indicating a PRS measurement. The operations of 1504 may be performed in accordance with examples as described herein. In some implementations, aspects of the operations of 1504 may be performed by a device as described with reference to FIG. 1.

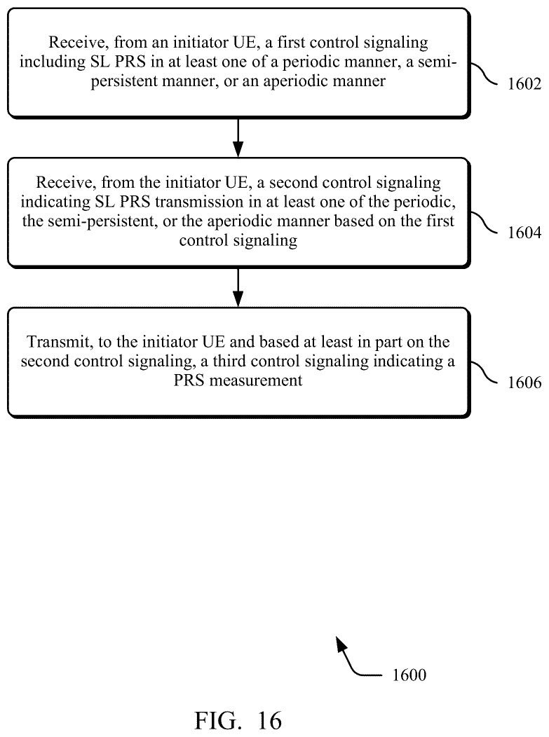

FIG. 16 illustrates a flowchart of a method 1600 that supports configuring sidelink positioning reference signals transmission in accordance with aspects of the present disclosure. The operations of the method 1600 may be implemented and performed by a device or its components, such as a UE 104 as described with reference to FIGS. 1 through 12. In some implementations, the device may execute a set of instructions to control the function elements of the device to perform the described functions. Additionally, or alternatively, the device may perform aspects of the described functions using special-purpose hardware.

At 1602, the method may include receiving, from an initiator UE, a first control signaling including SL PRS in at least one of a periodic manner, a semi-persistent manner, or an aperiodic manner. The operations of 1602 may be performed in accordance with examples as described herein. In some implementations, aspects of the operations of 1602 may be performed by a device as described with reference to FIG. 1.

At 1604, the method may include receiving, from the initiator UE, a second control signaling indicating SL PRS transmission in at least one of the periodic, the semi-persistent, or the aperiodic manner based on the first control signaling. The operations of 1604 may be performed in accordance with examples as described herein. In some implementations, aspects of the operations of 1604 may be performed by a device as described with reference to FIG. 1.

At 1606, the method may include transmitting, to the initiator UE and based at least in part on the second control signaling, a third control signaling indicating a PRS measurement. The operations of 1606 may be performed in accordance with examples as described herein. In some implementations, aspects of the operations of 1606 may be performed by a device as described with reference to FIG. 1.

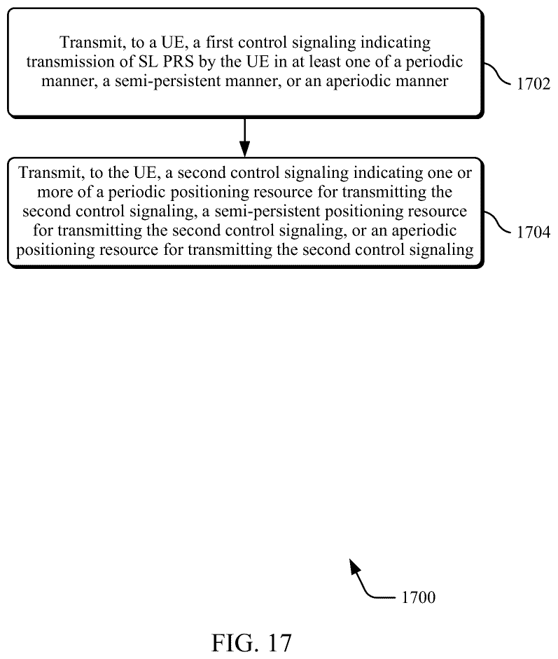

FIG. 17 illustrates a flowchart of a method 1700 that supports configuring sidelink positioning reference signals transmission in accordance with aspects of the present disclosure. The operations of the method 1700 may be implemented and performed by a device or its components, such as a base station 102 (e.g., a gNB) as described with reference to FIGS. 1 through 12. In some implementations, the device may execute a set of instructions to control the function elements of the device to perform the described functions. Additionally, or alternatively, the device may perform aspects of the described functions using special-purpose hardware.

At 1702, the method may include transmitting, to a UE, a first control signaling indicating transmission of SL PRS by the UE in at least one of a periodic manner, a semi-persistent manner, or an aperiodic manner. The operations of 1702 may be performed in accordance with examples as described herein. In some implementations, aspects of the operations of 1702 may be performed by a device as described with reference to FIG. 1.

At 1704, the method may include transmitting, to the UE, a second control signaling indicating one or more of a periodic positioning resource for transmitting the second control signaling, a semi-persistent positioning resource for transmitting the second control signaling, or an aperiodic positioning resource for transmitting the second control signaling. The operations of 1704 may be performed in accordance with examples as described herein. In some implementations, aspects of the operations of 1704 may be performed by a device as described with reference to FIG. 1.

It should be noted that the methods described herein describe possible implementations, and that the operations and the steps may be rearranged or otherwise modified and that other implementations are possible. Further, aspects from two or more of the methods may be combined. The order in which the methods are described is not intended to be construed as a limitation, and any number or combination of the described method operations may be performed in any order to perform a method, or an alternate method.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C, or AB or AC or BC, or ABC (i.e., A and B and C). Similarly, a list of one or more of A, B, or C means A or B or C, or AB or AC or BC, or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A first user equipment (UE) for wireless communication, comprising:
at least one memory; and
at least one processor coupled with the at least one memory and configured to cause the first UE to:
receive, from a network node, a first control signaling indicating transmission of sidelink (SL) positioning reference signals (PRS) by the first UE in at least one of a periodic manner, a semi-persistent manner, or an aperiodic manner; and
transmit, to a second UE, a second control signaling including SL PRS based at least in part on the received first control signaling.

2. The first UE of claim 1, wherein the network node comprises a base station.

3. The first UE of claim 1, wherein the first control signaling indicates transmission of SL PRS by the first UE in the semi-persistent manner, and the at least one processor is further configured to cause the first UE to:
receive, from the network node, a third control signaling indicating to activate transmission of SL PRS by the first UE in the semi-persistent manner; and
initiate, in response to the third control signaling, transmission of SL PRS by the first UE to the second UE in the semi-persistent manner.

4. The first UE of claim 3, wherein the at least one processor is further configured to cause the first UE to:
receive, from the network node, a fourth control signaling indicating to deactivate transmission of SL PRS by the first UE in the semi-persistent manner; and
cease, in response to the fourth control signaling, transmission of SL PRS by the first UE in the semi-persistent manner.

5. The first UE of claim 1, wherein the at least one processor is further configured to cause the first UE to:
transmit, to the second UE, a third control signaling indicating SL PRS transmission in at least one of the periodic, the semi-persistent, or the aperiodic manner based on the first control signaling; and
receive, from the second UE and based at least in part on the third control signaling, a fourth control signaling indicating a PRS measurement.

6. The first UE of claim 1, wherein the at least one processor is further configured to cause the first UE to:
receive, from the network node, a third control signaling indicating a configured grant (CG) configuration within a positioning frequency layer corresponding to a positioning resource set; and
transmit the second control signaling within a CG resource indicated by the CG configuration.

7. The first UE of claim 1, wherein the at least one processor is further configured to cause the first UE to:
receive, from the network node, a third control signaling indicating activation or deactivation of a configured grant (CG) resource for the SL PRS, the third control signaling further indicating a positioning resource identifier within a positioning resource set; and
activate or deactivate, in accordance with the third control signaling, the CG resource for the SL PRS.

8. The first UE of claim 7, wherein the third control signaling comprises a downlink control information (DCI) signaling.

9. The first UE of claim 1, wherein the at least one processor is further configured to cause the first UE to:
receive, from the network node, a third control signaling indicating one or more of a periodic positioning resource for transmitting the second control signaling, a semi-persistent positioning resource for transmitting the second control signaling, or an aperiodic positioning resource for transmitting the second control signaling; and
transmit the second control signaling using the indicated one or more of the periodic positioning resource, the semi-persistent positioning resource, and the aperiodic positioning resource.

10. (canceled)

11. A base station for wireless communication, comprising:
at least one memory; and
at least one processor coupled with the at least one memory and configured to cause the base station to:
transmit, to a user equipment (UE), a first control signaling indicating transmission of sidelink (SL) positioning reference signals (PRS) by the UE in at least one of a periodic manner, a semi-persistent manner, or an aperiodic manner; and
transmit, to the UE, a second control signaling indicating one or more of a periodic positioning resource for transmitting the second control signaling, a semi-persistent positioning resource for transmitting the second control signaling, or an aperiodic positioning resource for transmitting the second control signaling.

12. (canceled)

13. The base station of claim 11, wherein the first control signaling indicates transmission of SL PRS by the UE in the semi-persistent manner, and the at least one processor is further configured to cause the base station to:
transmit, to the UE, a third control signaling indicating to activate transmission of SL PRS by the UE in the semi-persistent manner.

14. (canceled)

15. The base station of claim 11, wherein the at least one processor is further configured to cause the base station to:
transmit, to the UE, a third control signaling indicating, for the SL PRS, a configured grant (CG) configuration within a positioning frequency layer corresponding to a positioning resource set.

16. The base station of claim 11, wherein the at least one processor is further configured to cause the base station to:
transmit, to the UE, a third control signaling indicating activation or deactivation of a configured grant (CG) resource for the SL PRS, the third control signaling further indicating a positioning resource identifier within a positioning resource set.

17. (canceled)

18. The base station of claim 11, wherein the at least one processor is further configured to cause the base station to:
transmit, to the UE, a fourth control signaling indicating activation or deactivation of a positioning resource within a positioning resource set for the SL PRS.

19. A first user equipment (UE) for wireless communication, comprising:
at least one memory; and
at least one processor coupled with the at least one memory and configured to cause the first UE to:
receive, from a second UE, a first control signaling including sidelink (SL) positioning reference signals (PRS) in at least one of a periodic manner, a semi-persistent manner, or an aperiodic manner;
receive, from the second UE, a second control signaling indicating SL PRS transmission in at least one of the periodic, the semi-persistent, or the aperiodic manner based on the first control signaling; and
transmit, to the second UE and based at least in part on the second control signaling, a third control signaling indicating a PRS measurement.

20. The first UE of claim 19, wherein the at least one processor is further configured to cause the first UE to:
receive the first control signaling within a configured grant (CG) configuration within a positioning frequency layer corresponding to a positioning resource set.

21. A processor for wireless communication, comprising:
at least one controller coupled with at least one memory and configured to cause the processor to:
receive, from a network node, a first control signaling indicating transmission of sidelink (SL) positioning reference signals (PRS) by the processor in at least one of a periodic manner, a semi-persistent manner, or an aperiodic manner; and
transmit, to a user equipment (UE), a second control signaling including SL PRS based at least in part on the received first control signaling.

22. The processor of claim 21, wherein the first control signaling indicates transmission of SL PRS by the processor in the semi-persistent manner, and the at least one controller is further configured to cause the processor to:
receive, from the network node, a third control signaling indicating to activate transmission of SL PRS by the processor in the semi-persistent manner; and
initiate, in response to the third control signaling, transmission of SL PRS by the processor to the UE in the semi-persistent manner.

23. The processor of claim 22, wherein the at least one controller is further configured to cause the processor to:
receive, from the network node, a fourth control signaling indicating to deactivate transmission of SL PRS by the processor in the semi-persistent manner; and
cease, in response to the fourth control signaling, transmission of SL PRS by the processor in the semi-persistent manner.

24. The processor of claim 21, wherein the at least one controller is further configured to cause the processor to:
receive, from the network node, a third control signaling indicating a configured grant (CG) configuration within a positioning frequency layer corresponding to a positioning resource set; and
transmit the second control signaling within a CG resource indicated by the CG configuration.
